(19) United States
(12) Patent Application Publication
(10) Pub. No.: US 2017/0053474 A1
(43) Pub. Date: Feb. 23, 2017

(54) SYSTEMS FOR PROVIDING WHEEL-BASED GAMES OF CHANCE

(71) Applicant: Gaming Arts, LLC, Las Vegas, NV (US)

(72) Inventors: Bobby Ray Harris, Henderson, NV (US); David Colvin, Las Vegas, NV (US); James B. Robertson, Sacramento, CA (US)

(21) Appl. No.: 15/242,334

(22) Filed: Aug. 19, 2016

Related U.S. Application Data
(60) Provisional application No. 62/207,162, filed on Aug. 19, 2015.

(51) Int. Cl. G07F 17/32

(52) U.S. Cl. CPC G07F 17/329; G07F 17/3272; G07F 17/3267; G07F 17/3244; G07F 17/3209; G07F 17/3225

(57) ABSTRACT

A system includes at least one player card having a plurality of player indicia usable by a player to play a game of chance, a randomization device configured to randomly select a plurality of house indicia for the game of chance, and a computing device programmed to determine whether the player card satisfies a winning criterion based on matching at least one of the player indicia with at least one of the house indicia. The system also includes a pay table having at least one base prize that is awardable to the player for satisfying the winning criterion, and that also includes an option for the player to either receive the base prize or to receive one of a plurality of randomly selectable prizes. The system also includes a rotatable wheel including the randomly selectable prizes that are selectable by rotating the wheel.

### CROSS REFERENCE TO RELATED APPLICATIONS

This application claims the benefit of U.S. Provisional Application Ser. No. 62/207,162 filed Aug. 19, 2015, entitled “Systems for Providing Wheel-Based Games of Chance”, the disclosure of which is hereby incorporated by reference in its entirety.

### BACKGROUND

The present application relates generally to games of chance and, more particularly, to systems for providing wheel-based games of chance.

Bingo games are typically played either as session-based games or as games provided on one or more gaming machines. Session-based bingo games are often played in a bingo room that has a flashboard or other display for displaying called numbers. A group of players typically play together with each player having one or more player cards that each includes a predetermined number of player numbers. The players mark off or “daub” the player numbers that match the called numbers during the game. A player who matches a winning pattern with the marked player numbers wins a prize based on a pay table for the game. The game typically ends when a player matches the winning pattern.

Player excitement is often increased when bingo games provide bonus opportunities to increase the prizes available to be won, or when bingo games provide large jackpots. The player excitement often translates into the players wagering more money and playing the games longer. Accordingly, casinos and gaming establishments may realize additional profits when games capture the players' interest and increase their excitement.

### BRIEF SUMMARY

In one embodiment, a system is provided that includes at least one player card having a plurality of player indicia usable by a player to play a game of chance, a randomization device configured to randomly select a plurality of house indicia for the game of chance, and a computing device programmed to determine whether the player card satisfies a winning criterion based on matching at least one of the player indicia with at least one of the house indicia. The system also includes a pay table having at least one base prize that is awardable for the player card satisfying the winning criterion, and that also includes an option for the player of the player card to either receive the base prize or to receive one of a plurality of randomly selectable prizes. The system also includes a rotatable wheel including the randomly selectable prizes that are selectable by rotating the wheel.

In another embodiment, a system is provided that includes at least one player card having a plurality of player indicia usable by a player to play a game of chance, wherein the player is enabled to select each of the player indicia from a pool of player indicia. The system also includes a randomization device configured to randomly select a plurality of house indicia for the game of chance, and a computing device programmed to determine whether the player card satisfies a winning criterion based on matching at least one of the player indicia with at least one of the house indicia. The system also includes a pay table having at least one base prize that is awardable for the player card satisfying the winning criterion, and a rotatable wheel including a plurality of sections that are selectable by rotating the wheel. Each player indicia is associated with a respective section, and the base prize is increased if a player indicia associated with the selected section matches a player indicia within the player card.

In yet another embodiment, a system is provided that includes a plurality of player cards, wherein each player card is usable by a player of a plurality of players to play a game of chance and each player card includes a plurality of player indicia. The system also includes a randomization device configured to randomly select a plurality of house indicia for the game of chance, and a computing device programmed to determine whether any player card satisfies a winning criterion based on matching at least one of the player indicia with at least one of the house indicia. The system also includes a pay table including at least one base prize that is awardable for the player card that satisfies the winning criterion, and a rotatable wheel including a plurality of randomly selectable prizes that are selectable by rotating the wheel. A selected prize is awarded to each player.

In another embodiment, a system is provided that includes at least one player card having a plurality of player indicia usable by a player to play a first game of chance. The system also includes a randomization device configured to randomly select a plurality of house indicia for the first game of chance, and a computing device programmed to determine whether the player card satisfies a winning criterion based on matching at least one of the player indicia with at least one of the house indicia. The system also includes a pay table including at least one base prize that is awardable for the player card satisfying the winning criterion, and a rotatable wheel including the plurality of randomly selectable sections that are selectable by rotating the wheel. Each section is associated with one of a plurality of prize multipliers. A prize multiplier associated with a selected section is applied to the base prize in a second game of chance that is played after the first game of chance ends.

In still another embodiment, a system is provided that includes a plurality of player cards. Each player card is usable by a player of a plurality of players to play a game of chance and wherein each player card includes a plurality of player indicia. The system also includes a randomization device configured to randomly select a plurality of house indicia for the game of chance, and a computing device programmed to determine whether any player card satisfies a winning criterion based on matching at least one of the player indicia with at least one of the house indicia. The system also includes a pay table including at least one base prize that is awardable for the player card that satisfies the winning criterion, and a rotatable wheel including a plurality of randomly selectable consolation prizes that are selectable by rotating the wheel. A selected consolation prize is awarded to each player in the event that no player card satisfies the winning criterion.

In another embodiment, a system is provided that includes at least one player card that is usable by a player to play a game of chance, wherein the player card includes a plurality of player indicia. The system also includes a randomization device configured to randomly select a plurality of house indicia for the game of chance, a computing device programmed to determine whether the player card satisfies a winning criterion based on matching at least one of the player indicia with at least one of the house indicia, and a rotatable wheel including a plurality of sections that are randomly selectable by rotating the wheel, wherein each section is associated with a house indicia number. The system also includes a pay table including at least one prize that is awardable for the player card satisfying the winning criterion within a variable number of house indicia calls.

In another embodiment, a system is provided that includes at least one player card that is usable by a player to play a game of chance, wherein the player card includes a plurality of player indicia. The system also includes a randomization device configured to randomly select a plurality of house indicia for the game of chance, a computing device programmed to determine whether the player card satisfies a winning criterion based on matching at least one of the player indicia with at least one of the house indicia, and a rotatable wheel including a plurality of sections that are randomly selectable by rotating the wheel, wherein each section is associated with a range of house indicia numbers. The system also includes a pay table having at least one prize that is awardable for the player card satisfying the winning criterion within a variable number of house indicia calls.

In yet another embodiment, a system is provided that includes at least one player card that is usable by a player to play a game of chance, wherein the player card includes a plurality of player indicia. The system also includes a randomization device configured to randomly select a plurality of house indicia for the game of chance, and a rotatable wheel including a plurality of sections that are randomly selectable by rotating the wheel, wherein each section is associated with a prize. The system also includes a computing device programmed to calculate an average cost of the prizes associated with the sections selectable by the rotatable wheel, and reduce the average cost of the prizes without changing a value of each prize.

### BRIEF DESCRIPTION OF THE DRAWINGS

FIG. 1 is a block diagram of an exemplary system for providing a game of chance.

FIG. 2 is a block diagram of an exemplary player ticket that may be used with the system shown in FIG. 1.

FIG. 3 is a block diagram of an exemplary pay table that may be used with the system shown in FIG. 1.

FIG. 4 is a plan view of an exemplary rotatable wheel that may be used with the system shown in FIG. 1.

FIG. 5 is a plan view of another exemplary rotatable wheel that may be used with the system shown in FIG. 1.

FIG. 6 is a plan view of another exemplary rotatable wheel that may be used with the system shown in FIG. 1.

FIG. 7 is a plan view of another exemplary rotatable wheel that may be used with the system shown in FIG. 1.

FIG. 8 is a block diagram of an exemplary system that may be used to play a game of chance using electronic or virtual tickets and/or player cards.

FIG. 9 is a block diagram of an exemplary computing device that may be used with the system shown in FIG. 8.

FIG. 10 is a block diagram of an exemplary gaming device that may be used with the system shown in FIG. 8.

FIG. 11 is a plan view of another exemplary rotatable wheel that may be used with the system shown in FIG. 1 or the system shown in FIG. 8.

FIG. 12 is a plan view of another exemplary rotatable wheel that may be used with the system shown in FIG. 1 or the system shown in FIG. 8.

FIG. 13 is a plan view of another exemplary rotatable wheel that may be used with the system shown in FIG. 1 or the system shown in FIG. 8.

### DETAILED DESCRIPTION

Embodiments described herein provide games of chance that may include one or more rotatable wheels. The games of chance may include bingo, keno, and/or any other suitable game of chance. While the following description is based on a bingo game of chance, it should be recognized that the description may be applicable to other games of chance.

In one embodiment, a bingo game is played as one of a plurality of bingo games in a game session. The game session may be played within a gaming establishment, such as a casino or a bingo hall. Alternatively, the bingo game may be played on one or more gaming devices and/or may be played in any suitable location.

One or more rotatable wheels may also be used or included within the game to provide additional prizes, prize multipliers, consolation prizes, or the like. In one embodiment, a player who wins a prize based on matching a winning pattern or otherwise satisfying a winning criterion in the game may be presented with an option to spin (or rotate) the wheel instead of receiving the prize. Alternatively, the player may spin the wheel in addition to receiving the prize.

The wheel may include a plurality of sections, with each section including one or more wheel indicia. The wheel may also include a pointer that points to a section and/or wheel indicia. The wheel indicia may include, for example, a bonus prize amount, a prize multiplier, a special symbol, and/or any other suitable indicia. When the player rotates the wheel, the wheel gradually slows down and stops with the pointer pointing at a randomly selected section.

As used herein with respect to a physical wheel, the term “randomly selected” refers to a player not being able to predict where the wheel will stop after the player spins the wheel due to various factors contributing to the section at which the pointer will point to when the wheel stops. These factors may include, for example, the force with which the player spins the wheel, the resistance to rotation of the wheel based on the internal friction between the wheel and an axis on which the wheel rotates, the resistance to rotation caused by the force exerted (if any) on the wheel by the pointer, and/or any other suitable factors.

As used herein with respect to a virtual or electronic implementation of the wheel, the term “randomly selected” refers to a randomly selected section or wheel indicia that a randomization device selects. For example, if a player presses a button or otherwise causes the wheel to rotate (or to be displayed as if the wheel is rotating), the randomization device may randomly select a section or wheel indicia of the wheel. A processor may then cause the wheel to be displayed as slowing down and coming to a stop with the pointer pointing at the randomly selected section or wheel indicia.

As used herein, a “game of chance” or “game” refers to a game that is played by a player in which an outcome of the game of chance is at least partially based on chance or a random selection of game components.

As used herein, the term “pattern-based” game refers to a game in which the winning criterion includes matching one or more patterns of player indicia with called house indicia. As a non-limiting example, bingo and bingo-related games may be considered pattern-based games. It should be recognized, however, that bingo and bingo-related pattern-based games may use more or less than 75 house indicia and/or may end with no winner being identified in contrast to traditional bingo games. Non-limiting examples of games that are not pattern-based games include keno and keno-related games, including keno and keno-related games that use more or less than the traditional 80 house indicia.

A game session refers to a period of time in which a group of related games of chance are conducted. The games are often conducted sequentially such that a first game is conducted during the game session and when the first game ends, a second game is conducted during the same game session. However, it should be recognized that at least a portion of the games within a game session may be offered concurrently with each other.

Gaming devices described herein may use real money for play, or may utilize a credit-based system in which the credits used for the games do not have a cash value. Similarly, prizes for the games may be in the form of credits, cash, and/or physical prizes such as televisions, automobiles, or the like.

In one embodiment, the play of a game, or the gameplay, includes the drawing or selection of a plurality of house indicia for one or more player cards. Alternatively, the play of a game may include revealing the house indicia that have been pre-selected for one or more player cards.

The term “house indicia” or “game indicia” refers to indicia, such as objects, graphics, symbols, numbers, letters, or the like, that are generated, called, or otherwise selected by a gaming establishment or an operator of the game (or by software, devices, and/or agents operating on behalf of the gaming establishment or operator). In one embodiment, house indicia are compared to player indicia on each player card to determine if each player card satisfies one or more winning conditions.

As used herein, the term “player indicia” refers to indicia, such as objects, graphics, symbols, numbers, letters, or the like, that are printed on, displayed on, or otherwise associated with a player card used by the player to play a game of chance. In at least some embodiments, the player indicia for each player card are selected before the player card is issued or distributed to a player.

The term “ball call” or “house indicia call” refers to a random selection of house indicia in connection with a game of chance. A ball call may generally refer to a random selection of a number or another suitable house indicia using a randomization device. A “ball,” as used herein, may be a round plastic, wood, or glass spherical object with a number or other indicia displayed thereon, or may be an electronic representation of a spherical object with a number or other indicia displayed thereon. It should be recognized that the term “ball” may also include non-spherical objects or electronic representations, such as cubes, electronic images, and/or the numbers or indicia by themselves.

As used herein, the term “pattern” refers to a predetermined combination of spaces of a player card or to a predetermined combination of indicia within the spaces. In at least some embodiments, a winning pattern is satisfied if a predetermined combination of player indicia included within the spaces of a player card are matched to house indicia called during the game.

As used herein, the terms “connect” and “couple” are not limited to only including direct connections. Rather, unless otherwise specified, indirect connections are included within the definitions of “connect” and “couple.” For example, two devices may be considered to be connected together even if there are other devices or components connected between the two devices. Any suitable means to connect or couple devices or components together may be used.

A player reward card refers to a physical or electronic card, token, or other device or data that enables a system to identify a player in connection with, among other things, a reward program or campaign. Accordingly, the player reward card may serve to identify the player and may enable gameplay, credits, funds, or other data to be associated with the player.

A player ticket (sometimes referred to as a “ticket”) may include one or more player cards for playing a game of chance. The player ticket may be a physical ticket that is manufactured from paper, cardboard, cardstock, plastic, and/or any other suitable material. Alternatively, the player ticket may be an electronic or virtual ticket that is transmitted to and/or generated by a device usable by the player to play the game of chance.

A player card refers to a card or other representation of player indicia that may be used by the player to play bingo or another game of chance. The player card typically includes a plurality of spaces that may display or include the player indicia.

Methods described herein may be embodied within a plurality of instructions stored within a memory device of a computing device. Moreover, a processor of the computing device, or of a computing device coupled to the memory device, executes the instructions to perform the functions described herein and/or to cause the functions described herein to be performed. The instructions may be grouped together to form one or more computer-readable program modules.

Computing devices typically include at least one processor and at least one memory device. The processor may be, without limitation, an x86-based logic circuit, an ARM-based logic circuit, and/or a system-on-a-chip circuit. It should be recognized that these examples are non-limiting, and a variety of other programmable circuits may be included within the definition of “processor.” The memory device may include random access memory (RAM), flash memory, read-only memory (ROM), hard disk drives, magnetic-based memory, and/or any other form of computer-readable memory.

A desktop computer is one example of a computing device. Other examples of computing devices include, without limitation, electronic gaming machines (also known as slot machines), kiosks, video lottery terminals, cell phones, tablets, PDAs, laptop computers, and smart watches. It should be recognized that computers or computing devices may be implemented as one or more virtual machines, virtual servers, and/or any other virtual device. A server is another type of computing device that may receive network connections from a computer or a plurality of computers or other computing devices.

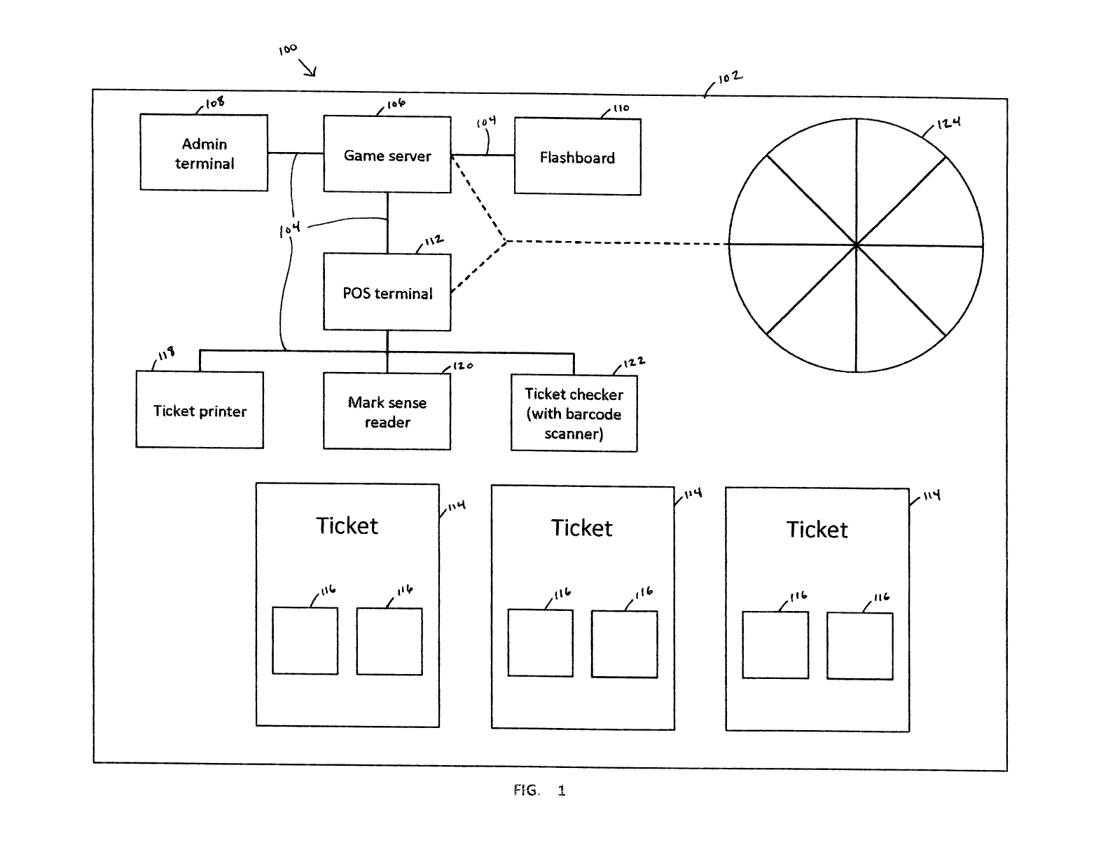

FIG. 1 is a block diagram of an exemplary system 100 for playing a game of chance. In one embodiment, system 100 may be used to play a bingo or bingo-related game of chance, a keno or keno-related game of chance, and/or any other suitable game of chance.

In an exemplary embodiment, system 100 is operated using components and devices within one or more gaming establishments 102. While only 1 gaming establishment 102 is illustrated within FIG. 1, it should be recognized that any suitable number of gaming establishments 102 may be provided within system 100. Exemplary gaming establishments 102 may include, without limitation, casinos, racetracks, bingo halls, keno parlors, or any other establishments. In another example, gaming establishments 102 may be residences or businesses in which one or more devices are located for playing or operating the game of chance. Gaming establishments 102 may additionally or alternatively include any combination of the examples described herein.

In one embodiment, devices and systems within gaming establishments 102 are communicatively coupled to each other via at least one network 104, such as a local area network (LAN), a casino area network (CAN), a wide area network (WAN), a metropolitan area network (MAN), and/or the Internet, for example. Alternatively, gaming establishments 102 may be separate rooms or sections of a casino or another facility that are communicatively connected together by network 104.

System 100 may include a game server 106 in communication with various local and/or remote devices using one or more communication protocols, which may include secure, encrypted communications. Game server 106 performs various functions associated with operation, management, and reporting for games of chance according to the embodiments described herein. Game server 106 may be connected to other devices via network 104 and/or via any other suitable local and/or wide area network using any of a number of standard wired and/or wireless communication protocols and technologies.

In one embodiment, an admin terminal 108 is coupled to game server 106. Admin terminal 108 may be used to control or configure aspects of the game of chance and/or to control or configure aspects of game server 106. For example, an employee or other personnel of gaming establishment 102 may use admin terminal 108 to identify the game or games of chance to be presented to the player, determine the number of indicia calls to be selected in the game of chance, initiate the game of chance, monitor the gameplay of the game of chance, and/or may monitor and/or manage any other suitable aspects of the game of chance. Such operations may be accomplished by interfacing with game server 106 via admin terminal 108, for example.

A flashboard 110 may be coupled to game server 106 for use in games of chance that include called indicia, such as called house indicia. In an embodiment in which game server 106 selects or otherwise determines the called house indicia, flashboard 110 may display the called indicia to players in gaming establishment 102. For example, in a bingo game, flashboard 110 may display the numbers called by game server 106 during the bingo game.

In addition, a POS terminal 112 may be coupled to game server 106 according to one embodiment. POS terminal 112 may be used to sell or otherwise provide one or more player tickets 114 and/or player cards 116 to one or more players of the game of chance. In some embodiments, POS terminal 112 may also be used to verify winning tickets 114 and/or player cards 116 by interfacing with one or more devices of system 100.

In one embodiment, a ticket printer 118 is coupled to POS terminal 112 to facilitate printing player tickets 114. Ticket printer 118 may print tickets 114 and/or player cards 116 on one or more sheets of paper that include one or more watermarks. Alternatively, ticket printer 118 may print the watermark on the receipt, or may include another security mechanism to facilitate preventing counterfeit receipts from being made.

A mark sense reader 120 may also be coupled to POS terminal 112 in one embodiment. Mark sense reader 120 may be used to automatically read player indicia selected by the player and/or other features of player ticket request forms submitted by players to be played during the game of chance. In one embodiment, players may write-in, input, or otherwise select player indicia on a partially blank player ticket request form by marking the desired player indicia on the form with a pen or pencil. The player ticket request form is then fed into mark sense reader 120, which reads the marks and communicates associated information to admin terminal 108 and/or game server 106 via POS terminal 112. In one embodiment, upon receipt of a wager at POS terminal 112 and verification of the data in the player request form, a player ticket 114 corresponding to the player ticket request form is then printed by ticket printer 118.

A ticket checker 122 may be coupled to POS terminal 112 in some embodiments. Ticket checker 122 may include a barcode scanner that is usable to read barcodes on player tickets 114 and/or player cards 116. In one embodiment, ticket checker 122 may receive data from physical and electronic player tickets 114 using the barcode scanner. It should be recognized that the barcodes read by ticket checker 122 may be linear or one-dimensional barcodes, two-dimensional barcodes, or may even include data represented in a form other than a barcode. In one embodiment, ticket checker 122 may read images and/or text indicative of data, such as currency or credits, usable with a game of chance. For example, ticket checker 122 may scan a paper receipt or voucher that includes an amount of currency or credits usable by the player within gaming establishment and may transmit the amount of credits to POS terminal 112, admin terminal 108, game server 106, and/or any other suitable device or system.

In one embodiment, a rotatable wheel 124 may be coupled to game server 106 and/or to POS terminal 112. Alternatively, wheel 124 may be a standalone wheel or may be coupled to another suitable system or device as desired. Wheel 124 may be used to display one or more prize multipliers, bonuses, or prizes as described more fully herein. In one embodiment, wheel 124 is a physical wheel that may be rotated or spun by a player upon the satisfaction of a predetermined criterion. The player may spin the wheel by grabbing and physically rotating the wheel. Alternatively, the player may spin the wheel by pressing a button or the like on a device, such as a tablet computing device or a gaming device, to cause the wheel to be spun by a motor or another device operated by game server 106, POS terminal 112, admin terminal 108, and/or any other suitable device. In an alternative embodiment, wheel 124 may be a virtual or electronically displayed wheel. In such an embodiment, the player may spin the wheel by pressing a button, icon, or another suitable portion of a tablet computing device or gaming device, for example, to cause wheel 124 to be electronically displayed as a spinning graphic or the like.

One or more tickets 114 may be used to play the game of chance as described more fully herein. In one embodiment, a plurality of players may play the game of chance by purchasing one or more tickets 114 for each player. Each ticket 114 may include one or more player cards 116 for displaying player indicia. In one embodiment, each player may be able to select the player indicia for each player card 116 as described above.

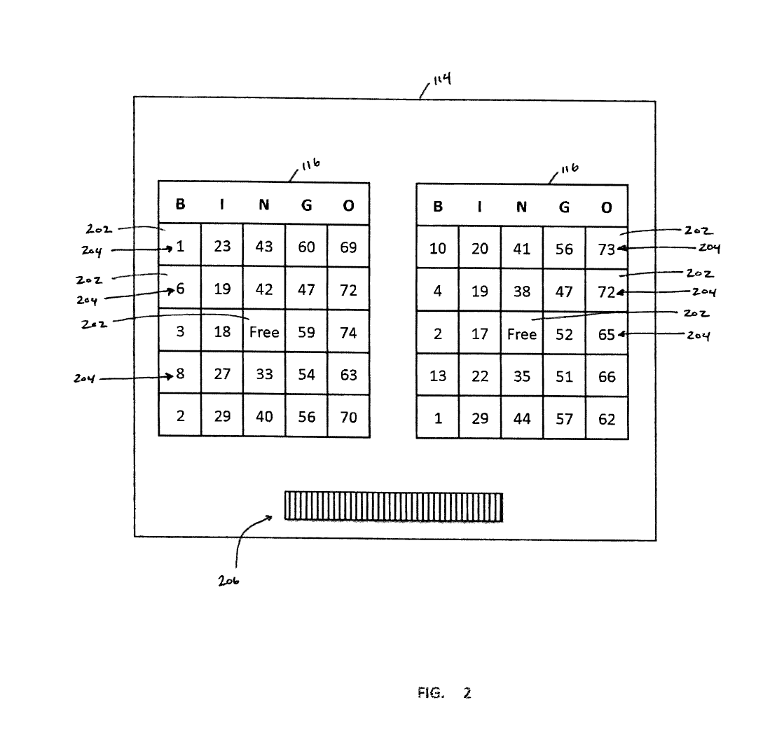

FIG. 2 is a block diagram of an exemplary player ticket 114 that may be used with system 100 (shown in FIG. 1). In an exemplary embodiment, ticket 114 includes a plurality of player cards 116. Alternatively, ticket 114 may include a single player card 116, or any suitable number of player cards 116.

Each player card 116 may include a plurality of spaces 202 for displaying player indicia 204. In an exemplary embodiment, each space 202 displays a single player indicia 204. Alternatively, two or more player indicia 204 may be displayed in each space 202. In another alternative embodiment, one or more spaces 202 may not include any player indicia 204.

In the example shown in FIG. 2, each player card 116 is a 5×5 player card 116 that may be used in a game of bingo. Accordingly, player card 116 includes a matrix of 5 rows and 5 columns that define 25 spaces 202. In one embodiment, a free space indicator is displayed in the center space 202 of player card 116 and the remaining 24 spaces 202 are filled with player indicia 204. In another embodiment, the free space indicator is displayed in the center space 202 and only the spaces 202 within a selected pattern are filled with player indicia 204. Center space 202 including the free space indicator is considered to be automatically filled or matched at the start of the game, and may include a “daub” or another marker to indicate that center space 202 has been filled.

In one embodiment, a barcode 206 is displayed on player card 116. Barcode 206 may include an encoded, machine-readable serial number or other identifier that identifies ticket 114.

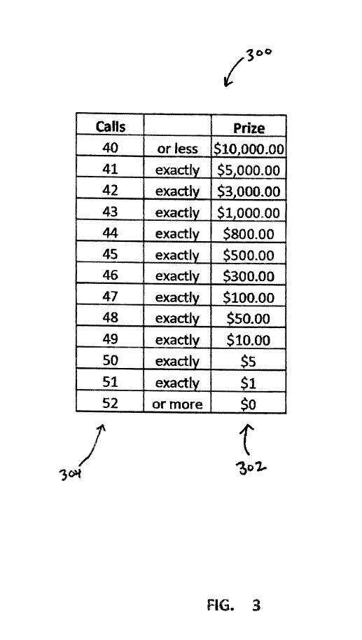

FIG. 3 is an exemplary pay table 300 that may be used with system 100 (shown in FIG. 1). Pay table 300 lists the prizes or payouts 302 that may be awarded to a player depending on a number 304 of house indicia, or ball calls, that were required for the winning player card pattern or patterns to be matched. For example, if a player card pattern was matched on the 47th ball call, the player wins a prize 302 of 100 credits.

In the example shown in FIG. 3, pay table 300 is associated with a coverall pattern as the winning pattern. However, it should be recognized that other pay tables may be used for a coverall pattern and/or for other patterns. While pay table 300 is shown as having a plurality of predetermined, or fixed prize amounts for matching the winning pattern within a predetermined number of ball calls, it should be recognized that pay table 300 may be set up to award a progressive or pari-mutuel prize in addition to, or in place of, the predetermined prize amounts.

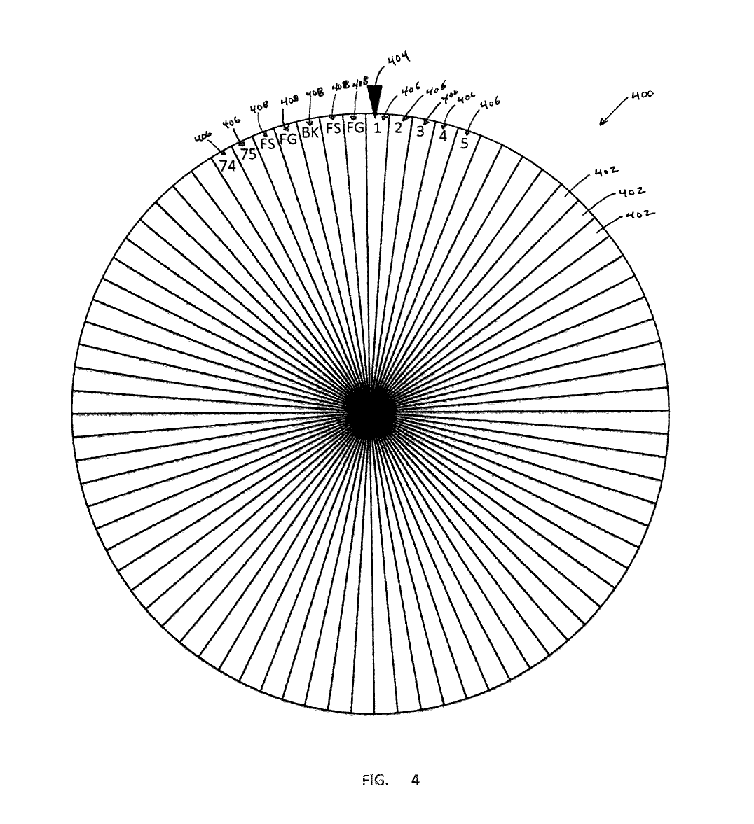

FIG. 4 is a plan view of an exemplary rotatable wheel 400 that may be used with system 100 (shown in FIG. 1). In an embodiment, wheel 400 is an embodiment of wheel 124 (shown in FIG. 1) and may be used as a bonus game or to present a bonus or enhanced prize to a player of a game of chance.

In one embodiment, wheel 400 may include a plurality of sections 402 that are randomly selectable by rotating wheel 400. For example, as wheel 400 is rotated, sections 402 may rotate past a pointer 404 or another suitable indicator. As wheel 400 slows down and stops, pointer 404 points to a section 402 that comes to rest in front of pointer 404. In other words, a section 402 is selected by pointer 404 when wheel 400 is rotated by the player or by another person or device.

Each section 402 may display a wheel indicia 406 that corresponds to a house indicia and/or a player indicia. Wheel indicia 406 may therefore include the numbers 1-75 in the case of a bingo game, the numbers 1-80 in the case of a keno game, or any other suitable indicia. In one embodiment, wheel indicia 406 may also include one or more special symbols 408 representing one or more special events that are triggered upon the special symbol 408 being selected. For example, special symbols 408 may include a “FS” or free spin symbol that enables the player to spin wheel 400 again, a “FG” or free game symbol that awards the player one or more free games of the game of chance or one or more free player tickets for the game of chance, a “BK” or bankrupt symbol that causes the player to lose a prize that the player would otherwise qualify to win during the game of chance, and/or any other suitable symbol.

In one embodiment, if a wheel indicia 406 is selected that matches a player indicia 204 within a winning pattern on a player card 116, the prize that the player would otherwise win is increased. For example, the prize may be doubled, may be tripled, may be increased by a fixed amount, or the prize may be replaced or added to a progressive or pari-mutuel prize associated with wheel indicia 406. Alternatively, the player may win one or more free games or player cards, and/or any other suitable prize in addition to, or in place of, the prize that the player would otherwise win as a result of matching the winning pattern.

In another embodiment, the player may win an increased prize, or a separate prize, if a wheel indicia 406 is selected that matches a player indicia 204 within a player card 116 regardless of whether a winning pattern or other winning criterion is satisfied. For example, in a U-Pick'Em or similar game, a player may choose the player indicia 204 to be played on a player card 116. The winning criterion for such a game may include matching a predetermined number of player indicia 204 with the called house indicia rather than matching a predetermined pattern, or the winning criterion may include matching a winning pattern such as a coverall pattern. In such a game, if the player spins wheel 400 and a wheel indicia 406 matches a player indicia 204 that the player selected for player card 116, the player may win a prize.

In one embodiment, a player may be entitled to spin wheel 400 if a winning criterion is satisfied, such as matching a winning pattern or matching a predetermined number of player indicia 204 with the called house indicia during the game. Alternatively, the player may automatically be entitled to spin wheel 400 during each game, or upon any other suitable criterion.

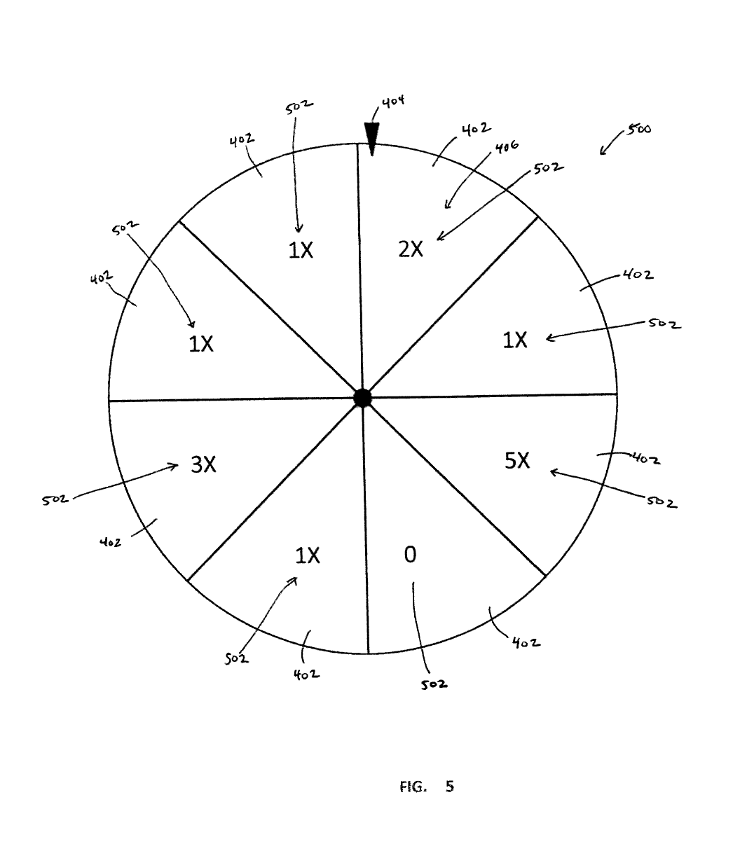

FIG. 5 is a plan view of another rotatable wheel 500 that may be used with system 100 (shown in FIG. 1). In one embodiment, wheel 500 is substantially similar to wheel 400 (shown in FIG. 4) and similar components are labeled in FIG. 5 with the same reference numerals used in FIG. 4.

In one embodiment, wheel 500 includes a plurality of sections 402 that are each associated with (and that each display) one or more wheel indicia 406, such as one or more prize multipliers 502. If a player satisfies a winning criterion during the play of a game of chance such that the player is entitled to win a prize (sometimes referred to as a “base prize”) based on a pay table 300 for the game, the player may be presented with an option to spin wheel 500. When wheel 500 comes to a stop, the selected section 402 identifies prize multiplier 502 to be applied to the base prize the player won. In one embodiment, prize multipliers 502 may include a 2× (i.e., multiplier of 2 that doubles the base prize), a 3× (i.e., a multiplier of 3 that triples the base prize), a OX (i.e., a multiplier of 0 that causes the player to lose the base prize), and/or any other suitable multiplier. Each section 402 may include a unique prize multiplier 502 value, or two or more sections 402 may include the same prize multiplier 502 as desired.

In one embodiment, a prize multiplier 502 may be selected in advance of a game session, such as in advance of an upcoming bingo game session. For example, at the end of a current game session (or at another suitable time during the current game session), a player may be selected to spin wheel 500. The player may be selected as a result of winning a bingo game during the current game session, or may be selected in another suitable fashion. The player may then spin wheel 500 and whichever prize multiplier 502 is randomly selected may be applied to all or a portion of the prizes that may be won in the upcoming game session. For example, if the player spins wheel 500 and a prize multiplier of 3× is randomly selected, each prize that is won in the upcoming game session may be multiplied by the selected prize multiplier 502 (i.e., may be tripled in this example).

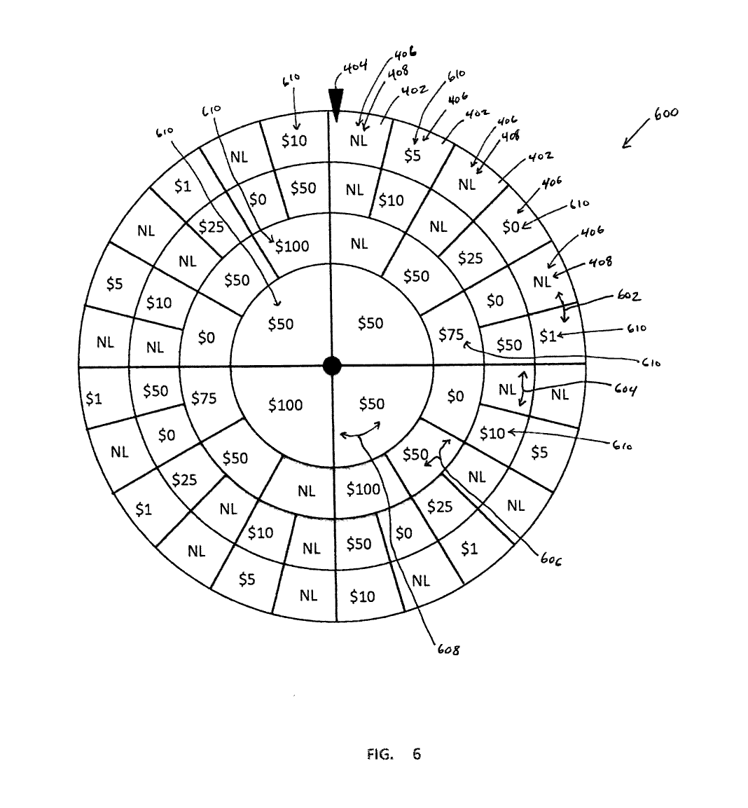

FIG. 6 is a plan view of another rotatable wheel 600 that may be used with system 100 (shown in FIG. 1). In one embodiment, wheel 600 is substantially similar to wheel 400 (shown in FIG. 4) and similar components are labeled in FIG. 6 with the same reference numerals used in FIG. 4.

In an embodiment, wheel 600 includes a plurality of randomly selectable sections 402 arranged in a plurality of concentric rings. For example, as illustrated in FIG. 6, wheel 600 includes a first or outer ring 602, a second or middle ring 604 encircled by first ring 602, a third or inner ring 606 encircled by second ring 604, and a fourth or innermost ring 608 encircled by third ring 606. While FIG. 6 illustrates sections 402 arranged in 4 rings, it should be recognized that wheel 600 may include any suitable number of rings as desired.

Each ring includes a set of wheel indicia 406 displayed within sections 402 of each ring. For example, first ring 602 includes a first set of wheel indicia 406, second ring 604 includes a second set of wheel indicia 406, third ring 606 includes a third set of wheel indicia 406, and fourth ring 608 includes a fourth set of wheel indicia 406.

In the embodiment shown in FIG. 6, each section 402 within each set of wheel indicia 406 includes or displays a randomly selectable prize 610 or a randomly selected special symbol 408 that is selected by rotating wheel 600. For example, a player may rotate wheel 600 and the section 402 that pointer 404 is pointing to when wheel 600 stops identifies the selected prize 610 or special symbol 408.

In one embodiment, special symbols 408 may include a “Next Level” (NL) symbol that enables the player to spin wheel 600 again to select a prize 610 or special symbol 408 within the next inner ring. For example, if the player spins wheel 600 a first time, a prize 610 or special symbol 408 within first ring 602 is randomly selected. If a special “Next Level” symbol 408 is selected, the player spins wheel 600 again to select prize 610 or special symbol 408 within second ring 604. Each time a special “Next Level” symbol 408 is selected, the player spins wheel 600 again for the next inner ring. Once a prize 610 is selected (instead of the special “Next Level” symbol 408), the player wins the selected prize 610 and the game may end.

In one embodiment, wheel 600 may be used to select consolation prizes for a bingo game or another game of chance. For example, if no player within a session bingo game matches a winning pattern within a predetermined number of ball calls, a player may be designated or chosen to spin wheel 600. Whichever prize 610 is randomly selected as a result of spinning wheel 600 may be awarded to each player playing the session bingo game as a consolation prize. In one embodiment, a prize 610 of $0 may be selected such that the players of the session bingo game may not receive any consolation prize for the game. It should be recognized that the foregoing embodiment may be used in other suitable games rather than just being limited to a session bingo game. In addition, wheel 600 may be used to provide any suitable prizes in addition to, or in place of, consolation prizes for bingo games.

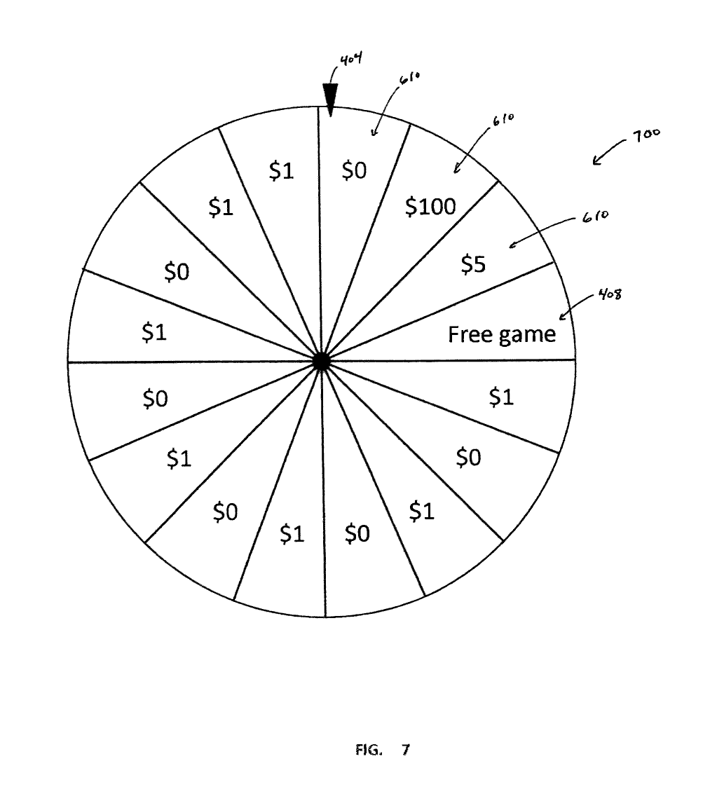

FIG. 7 is a plan view of another rotatable wheel 700 that may be used with system 100 (shown in FIG. 1). In one embodiment, wheel 700 is substantially similar to wheel 400 (shown in FIG. 4) and wheel 600 (shown in FIG. 6) and similar components are labeled in FIG. 7 with the same reference numerals used in FIG. 4 and FIG. 6.

In one embodiment, wheel 700 includes a plurality of randomly selectable sections 402 that each includes or displays a prize 610 or a special symbol 408. Each prize 610 may be a fixed amount of money or credits, may be a prize of $0, and/or may be any other suitable type of prize. Special symbols 408 may include, without limitation, a free game or player card 116 or any other suitable symbol.

In one embodiment, the prize 610 or symbol 408 that is selected is awarded to each player of a game session. For example, if a plurality of players are playing a session bingo game, each player will receive the prize 610 or symbol 408 that is selected. In one embodiment, the player (or players) who wins the bingo game is enabled to spin wheel 700. Alternatively, any player may be selected to spin wheel 700 using any suitable criterion.

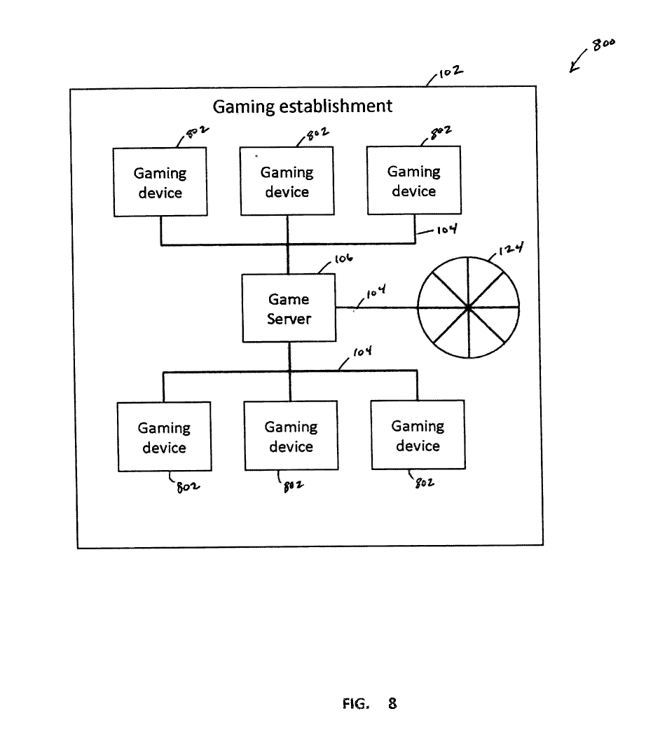

FIG. 8 is a block diagram of an exemplary system 800 that may be used to play an electronic game of chance, such as bingo or keno. In one embodiment, one or more player tickets 114, player cards 116, pay tables 300, wheels 124, and/or any other suitable components of the embodiments described herein may be used with the game of chance implemented by system 800.

System 800 may be operated using components and devices within one or more gaming establishments 102. It should be recognized that any suitable number of gaming establishments 102 may be provided within system 800.

In one embodiment, devices and systems of gaming establishment 102 are communicatively connected to at least one network 104, such as a local area network (LAN), a casino area network (CAN), a wide area network (WAN), a metropolitan area network (MAN), and/or the Internet, for example. It should be recognized that network 104 may be a wired Ethernet network, a wireless Ethernet network, a combination of wired and wireless Ethernet networks, or any other suitable wired and/or wireless network.

In one embodiment, gaming establishment 102 includes one or more game servers 106. Game server 106 is coupled to a plurality of gaming devices 802 through network 104.

In one embodiment, game server 106 is a server computer (or “server”) that monitors and controls the games played on gaming devices 802. In addition, game server 106 may administer other tasks that enable games to be played on gaming devices 802. For example, game server 106 may facilitate authenticating gaming devices 802 and the players using gaming devices 802, and may facilitate allocating payments or credits between players and gaming establishment 102 (or the operator of the game). Game server 106 may include payment processing capabilities to enable players to receive electronic funds from a bank or another financial institution or to deposit electronic funds to the bank or financial institution. Alternatively, the payment processing capabilities may be included in a separate server or another device that is communicatively connected to game server 106. In addition, game server 106 or another suitable server may facilitate tracking and administering player rewards.

Gaming devices 802 may include one or more gaming kiosks or terminals, electronic gaming machines (EGMs) (also known as “slot machines”), lottery kiosks or terminals, desktop computers, or any other suitable device. Gaming devices 802 may also include one or more mobile gaming devices 802, such as, without limitation, cellular phones, tablet computing devices, laptops, or any other suitable device. Mobile gaming devices 802 may connect to game server 106 and network 104 via a suitable wireless data network.

One or more rotatable wheels 124 may be included within system 800. In one embodiment, wheel 124 is coupled to game server 106 and is operated and/or activated by server 106 such that game server 106 may cause wheel 124 to spin upon the satisfaction of a suitable criterion. Alternatively, wheel 124 may be coupled to gaming devices 802 and may be operated and/or activated by gaming devices 802 such that gaming devices 802 may cause wheel 124 to spin upon the satisfaction of a suitable criterion. In another embodiment, wheel 124 is a standalone wheel that is not coupled to either game server 106 or gaming devices 802.

Wheel 124 may be a physical wheel 124 with a plurality of sections 402 for displaying one or more wheel indicia 406 as described above with reference to FIG. 4, for example. Alternatively, wheel 124 may be a virtual or electronic representation of a wheel that is displayed within one or more gaming devices 802 and/or that is displayed within one or more television screens, computer monitors, or the like. Wheel 124 may be implemented to include any features and/or aspects of other wheels described herein, including wheel 400 (shown in FIG. 4), wheel 500 (shown in FIG. 5), wheel 600 (shown in FIG. 6), and/or wheel 700 (shown in FIG. 7).

In an embodiment in which wheel 124 is a physical wheel (as opposed to a virtual wheel), a player may spin wheel 124 by grasping an edge or another suitable portion of wheel 124 and propelling wheel 124 in a circular motion. Alternatively, the player may press a button or the like on gaming device 802 or another suitable device to cause wheel 124 to be automatically spun by gaming device 802 and/or game server 106. When wheel 124 stops, the section 402 that pointer is pointing to identifies the selected section 402 and wheel indicia 406.

In an embodiment in which wheel 124 is a virtual wheel, the player may spin wheel 124 by pressing a button or the like on gaming device 802 to cause gaming device 802 and/or game server 106 to virtually spin wheel 124 (i.e., to cause wheel 124 to be graphically displayed in a rotating manner). A section 402 may be randomly selected by a randomization device of gaming device 802 or game server 106, for example, to be the selected section 402. The wheel indicia 406 on selected section 402 therefore becomes the randomly selected wheel indicia 406 for the wheel spin. In such an embodiment, wheel 124 may be displayed as gradually slowing down after being spun such that wheel 124 stops with the selected section 402 being pointed to by pointer 404.

During operation, the player operates a gaming device 802 and initiates a gaming session for playing one or more games of chance (“games”). Optionally, the player inserts a player reward card or enters a player reward number or other identification information into gaming device 802. If the identification information is entered, gaming device 802 transmits the identification information to game server 106 or to another suitable device or system for authentication. Alternatively, player identification or authentication may be accomplished locally within gaming device 802. Game server 106 may establish the player's identity and may associate the gameplay with the player account. Game server 106 authenticates the player and gaming device 802 and authorizes the player to play the game or games on gaming device 802 if desired or required.

When play of the game is initiated, during selection of the game, or during play of the game, the player may be required to purchase or generate credits. The player may purchase or generate credits by inserting cash or a voucher into gaming device 802 or another device. Alternatively or additionally, the player may transfer credits or cash to gaming device 802 from a banking account, credit account, gaming establishment account, and/or gaming company account. In one embodiment, computer-generated credits may be used with gaming device 802, for example, as part of a free-to-play game.

The player selects a game to play and enters a wager on gaming device 802. For example, the player may select an electronic bingo game to play on gaming device 802. Gaming device 802 transmits data representative of the selected game and the wager to game server 106.

The player then plays the game on gaming device 802. The following gameplay is described as being administered by game server 106. However, it should be recognized that the gameplay (i.e., the play of the game of chance) may be alternatively or additionally administered by gaming device 802. For example, if gaming device 802 is a cellular phone or a tablet computing device, the gameplay may be administered through an application installed on gaming device 802.

In one embodiment, the player may play a game of bingo by selecting one or more game tickets and/or player cards issued by game server 106. In one embodiment, tickets and/or player cards are substantially similar to the tickets and/or player cards described above with reference to FIGS. 1 and 2 and may be displayed and operated in a similar manner (i.e., to look and operate substantially the same as shown in FIGS. 1 and 2). Each ticket may include one or more player cards with a plurality of spaces or displaying player indicia 204.

A plurality of house indicia are called or selected by game server 106 and are displayed on gaming devices 802. The called house indicia are compared to player indicia 204 on each player card 116. Player indicia 204 that match the selected house indicia (referred to herein as “matching indicia”) are daubed or otherwise marked on the respective player card 116 displayed within each gaming device 802. If the matched indicia match a winning pattern or otherwise satisfy a winning criterion, the player of the player card 116 with the matched winning pattern may win a prize according to an associated pay table 300.

In one embodiment, the player that satisfies the winning criterion with one or more player cards 116 may spin wheel 124 to determine a bonus prize, a prize multiplier, and/or any other suitable award. For example, if the player wins a base prize, the player may have the option to spin wheel 124 to replace or increase the base prize with the results of the wheel spin in a similar manner as described above with reference to FIGS. 4-7.

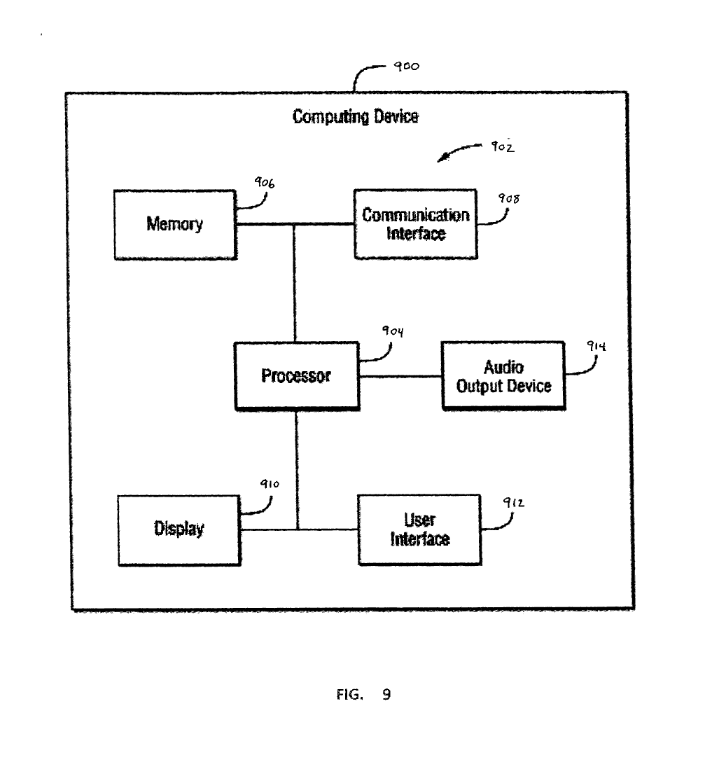

FIG. 9 is a block diagram of a computing device 900 that may be used with system 800 (shown in FIG. 8). More specifically, in one embodiment, one or more gaming devices 802 and/or game servers 106 described in system 800 may be implemented as a computing device 900.

Computing device 900 includes a plurality of computing device components 902, such as a processor 904, a computer-readable memory device 906, and a communication interface 908. In one embodiment, computing device 900 may also include a display 910, a user interface 912, and/or an audio output device 914. It should be recognized that memory device 906, communication interface 908, display 910, and user interface 912 (if provided) may be connected to processor 904 and/or to each other via any suitable bus or busses, interfaces, or other mechanisms.

Processor 904 includes any suitable programmable circuit including one or more microcontrollers, microprocessors, application specific integrated circuits (ASICs), systems on a chip (SoCs), programmable logic circuits (PLCs), field programmable gate arrays (FPGAs), and/or any other circuit capable of executing the functions described herein. The above examples are exemplary only, and thus are not intended to limit in any way the definition and/or meaning of the term “processor.”

Memory device 906 is an electronic storage device that includes transitory or non-transitory computer readable media, such as, without limitation, random access memory (RAM), flash memory, a hard disk drive, a solid state drive, a compact disc, a digital video disc, and/or any suitable memory. Memory device 906 may include data as well as instructions that are executable by processor 904 to program processor 904 to perform the functions described herein. For example, the games described herein may be performed by one or more processors 904 executing instructions stored within one or more memory devices 906.

Communication interface 908 may include, without limitation, a network interface controller (NIC) or adapter, a radio frequency (RF) transceiver, a public switched telephone network (PSTN) interface controller, or any other communication device that enables computing device 900 to operate as described herein. In one embodiment, communication interface 908 may connect to communication interfaces 908 of other computing devices 900 of system 800 through network 104 or another network using any suitable wireless or wired communication protocol.

Display 910 may include, without limitation, a liquid crystal display (LCD), a vacuum fluorescent display (VFD), a cathode ray tube (CRT), a plasma display, a light-emitting diode (LED) display, a projection display, and/or any suitable visual output device capable of displaying graphical data and text to a user. For example, display 910 may be used to display a graphical user interface to a player or an administrator, one or more images associated with a game of chance such as a bingo, keno, or lottery game, player statistics, gameplay data, and/or any other suitable data.

User interface 912 may include, without limitation, a keyboard, a keypad, a touch screen or touch-sensitive display, a mouse, a scroll wheel, a pointing device, an audio input device employing speech-recognition software, a video input device that registers movement of a user, and/or any other suitable device that enables the user to input data into computing device 900 and/or retrieve data from computing device 900.

Audio output device 914 may include, without limitation, one or more speakers, or any other device that enables data to be audibly output from computing device 900. For example, gameplay data and/or music may be audibly output from audio output device 914. In addition, if the player wins a prize, audio output device 914 may be used to alert the player and/or others about the win.

While the foregoing computing device components 902 have been described as being included within a computing device 900, it should be recognized that at least some computing devices 900 may not include each component 902. In addition, a computing device 900 may include any suitable number of each individual computing device component 902. For example, a computing device 900 may include a plurality of processors 904 or processor cores, a plurality of memory devices 906 (of the same or different types, sizes, etc.), and/or a plurality of displays 910.

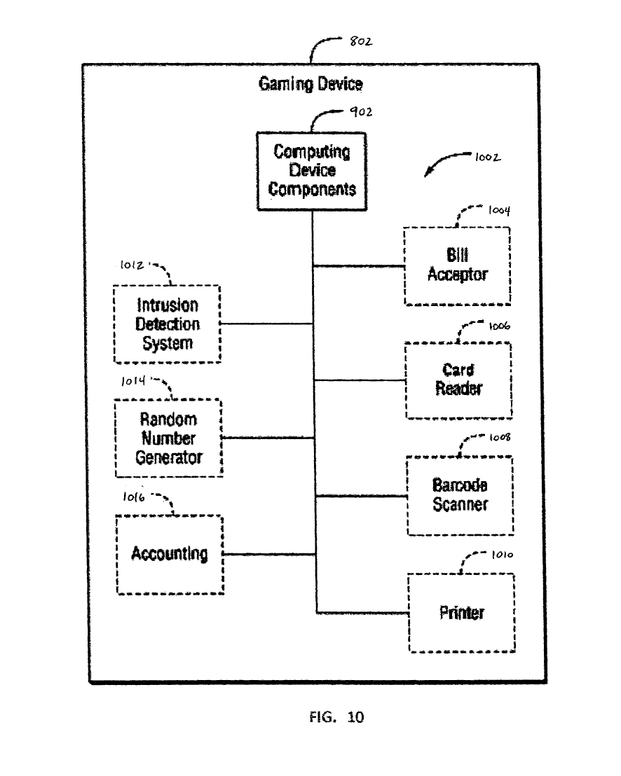

FIG. 10 is a block diagram of an exemplary gaming device 802 that may be used with system 800 (shown in FIG. 8). As described above, gaming device 802 may be a computing device 900 that includes a plurality of computing device components 902. In addition, gaming device 802 may include a plurality of gaming device components 1002 including a bill acceptor 1004, a card reader 1006, a barcode scanner 1008, a printer 1010, an intrusion detection system 1012, a randomization device 1014, and/or an accounting interface 1016.

It should be recognized that in some embodiments, a gaming device 802 may not include each gaming device component 1002 illustrated in FIG. 10. For example, if gaming device 802 is a cellular phone, gaming device 802 may not include bill acceptor 1004, card reader 1006, barcode scanner 1008, and/or printer 1010. Rather, in some embodiments, the functions of each omitted gaming device component 1002 may be replaced by equivalent software, hardware, and/or firmware if desired. For example, the functionality of card reader 1006 and/or barcode scanner 1008 may be implemented by a cellular phone camera.

Bill acceptor 1004 is a payment input device that enables gaming device 802 to receive and identify paper currency. For example, bill acceptor 1004 may receive and identify physical items associated with a monetary value, such as dollar bills or other currency, that are inserted into bill acceptor 1004. In one embodiment, bill acceptor 1004 includes a scanner that scans paper currency inserted therein. Bill acceptor 1004 may also include optical character recognition (OCR) capabilities that enable bill acceptor 1004 to identify the amount of currency inserted into bill acceptor 1004 from a scanned image of the currency. Bill acceptor 1004 may transmit data representative of the amount of currency inserted into gaming device 802 to processor 904, for example. Processor 904 may cause the amount of currency to be converted into credits usable with the game, and may add the credits to the player's credit balance or account.

Card reader 1006 is a device that “reads,” or obtains data encoded in, player reward cards or other cards or media that are inserted into reader 1006. In one embodiment, card reader 1006 is a magnetic card reader that reads barcodes or magnetic strips included within a player reward card. In another embodiment, card reader 1006 wirelessly reads data encoded within the player reward card by accessing a chip, such as a radio frequency identification (RFID) chip, embedded within the card. Card reader 1006 decodes the data obtained from the cards and transmits the decoded data to processor 904. In one embodiment, card reader 1006 is used to read player identification information encoded within player reward cards. Processor 904 may transmit the player identification information to game server 106 to identify the player, to allow for the transfer of funds or credits, to facilitate authenticating the player, and/or to authorize the player to play a game on gaming device 802. In one embodiment, the player may “log in” to gaming device 802 by swiping the player reward card or otherwise passing the player reward card through, or inserting the player reward card within, card reader 1006. In another embodiment, the player may enter a number or other identifier associated with the player reward card into gaming device 802, through user interface 912 for example, instead of using card reader 1006. In another embodiment, the insertion of the player reward card and player entering the identifier into user interface 912 may be combined. In yet another embodiment, the player may use a near field communication (NFC) device, such as an NFC device incorporated within communication interface 908, to read the player reward card or data representative of the player card.

In one embodiment, barcode scanner 1008 is an optical or a magnetic scanner that is optimized to read barcodes on media positioned proximate to scanner 1008. For example, barcode scanner 1008 may be optimized to read barcodes printed on paper receipts (sometimes referred to as “tickets” or vouchers, not to be confused with game or player tickets that may include player indicia and the like) and/or barcodes displayed electronically on a cell phone or tablet computing device. It should be recognized that the barcodes read by barcode scanner 1008 may be linear or one-dimensional barcodes, two-dimensional barcodes, or may even include data represented in a form other than a barcode. For example, barcode scanner 1008 may read images and/or text indicative of data, such as currency or credits, usable with gaming device 802. Barcode scanner 1008 extracts the data from the barcode and transmits the data to processor 904. For example, barcode scanner 1008 may scan a paper receipt or voucher that includes an amount of currency or credits usable by the player with a gaming device 802 and may transmit the amount of credits to processor 904. In such an example, barcode scanner 1008 may act as a payment input device to receive or read one or more physical items associated with a monetary value. Processor 904 may cause the amount of currency or credits to be added to a currency or credit balance for the player on gaming device 802 or on another suitable device or system. Processor 904 may also cause the amount of currency or credits to be displayed to the player on display 910 to inform the player how many credits or currency is available to be used in playing a game.

Printer 1010 may be used to print paper receipts (also known as tickets as described above) that indicate an amount of currency or credits available to the player. In many locations, the tickets or receipts may alternatively be referred to as vouchers. Printer 1010 may act as a payment output device that enables a player to cash out or withdraw money or credits from gaming device 802 by printing a voucher representative of the money or credits when the player initiates a cash out operation using, for example, user interface 912 of gaming device 802. In one embodiment, printer 1010 is a thermal printer that is fed by a roll of paper or any suitable paper stock. In a further embodiment, the roll of paper includes one or more watermarks that are visible when printer 1010 has printed the receipt on the paper. Alternatively, printer 1010 may print the watermark on the receipt, or may include another security mechanism to facilitate preventing counterfeit receipts from being made. For example, printer 1010 may include an image or a code on the receipt that identifies gaming device 802, printer 1010, or another component of gaming device 802 along with a time that the receipt was printed. Other suitable security mechanisms may be used as well. It should be recognized that barcode scanner 1008 and printer 1010 may cooperate such that a security mechanism printed on the receipt may be received and validated by barcode scanner 1008, in conjunction with processor 904, for example. Barcode scanner 1008 may be located remotely from gaming device 802, such as within a redemption kiosk, a casino cage, or the like.

Intrusion detection system 1012 may notify processor 904 if a case, cabinet, or other housing enclosing components of gaming device 802 is opened or modified without authorization. In one embodiment, intrusion detection system 1012 includes a pair of contacts that transmit an electronic signal to processor 904 if the housing of gaming device 802 is opened (e.g., if the opening of the housing separates the contacts). In another embodiment, intrusion detection system 1012 may include a light sensor that detects a change in the light within the housing of gaming device 802. Intrusion detection system 1012 may also include a key or another mechanism for disabling the transmission of the signal to processor 904 in the event that maintenance or other authorized access to components of gaming device 802 is desired.

In one embodiment, intrusion detection system 1012 includes a software program (a “monitoring program”) that monitors one or more applications installed on gaming device 802. For example, if gaming device 802 is a cell phone that includes an application for playing the game thereon, the monitoring program may monitor the application to determine whether the application is modified without authorization. In one embodiment, the monitoring program stores a hash value or a digital fingerprint of the application when the application is installed and/or when the application undergoes authorized modification (e.g., if the application is updated or patched). However, if the monitoring program determines that the application has been modified without authorization, the monitoring program may cause a signal or another notification to be transmitted to processor 904. For example, the monitoring program may periodically calculate a new hash value of the application and/or create a new digital fingerprint of the application. The monitoring program then compares the new hash value and/or digital fingerprint to the stored hash value and/or digital fingerprint. If the hash values or fingerprints are different, the monitoring program may determine that the application has been modified without authorization. It should be understood that the hash value, the monitoring program, and/or the digital fingerprint may be generated by any suitable means and may be encrypted for additional security.

In response to the signal or notification from intrusion detection system 1012 and/or the modification program, processor 904 may perform one or more actions. For example, processor 904 may alert an administrator within gaming establishment 102 by transmitting a message via communication interface 908, may cause audio output device 914 to emit an alarm or another audible alert, may cause display 910 to display an error or a warning, and/or may disable the application and/or gaming device 802 such that the game is unable to be played on gaming device 802.

In one embodiment, randomization device 1014 is an electronic random number generator (RNG) 1014 or a permutation generator that may be implemented by a dedicated hardware device with associated embedded software. Alternatively, RNG 1014 or the permutation generator may be implemented entirely in software executing on gaming device 802. RNG 1014 may be used to randomly determine a game outcome for the game of chance. In one embodiment, RNG 1014 or the permutation generator provides house or game draws of between 1 and n numbers, where n may be a suitable number based on the game type selected to be played by the player. RNG 1014 or the permutation generator may be programmed via hardware, software, or firmware to provide a particular range of numbers (or other indicia) and numbers of draws for a particular application. For example, in one embodiment of bingo according to the present disclosure, RNG 1014 or the permutation generator provides 45 randomly generated numbers having values between 1 and 75 for each game. In addition, RNG 1014 or the permutation generator may be used to randomly select a plurality of player indicia to be used with one or more player cards. In embodiments in which a processor, such as processor 904, is described as randomly selecting indicia, it should be recognized that processor 904 may interface with randomization device 1014 or the permutation generator to select the indicia. In other embodiments, processor 904 may include randomization device 1014 or the permutation generator, or may execute instructions to perform the functions of randomization device 1014 or the permutation generator.

Accounting interface 1016 is used to interface with an accounting system, such as a slot accounting system, at or operated by a gaming establishment 102. Accounting interface 1016 may include or be connected to a network interface, such as communication interface 908 for use in communicating gameplay data, player identification information, and/or other data to the accounting system for accounting and/or auditing purposes.

In some embodiments, an operator of system 800 may desire to calculate and/or reduce a cost of the prizes awarded as a result of spinning wheel 124. For example, if wheel 124 is used to determine an amount of a consolation prize that is awarded to all players in a game, the consolation prize may constitute the single largest expense that results from operating the game. The operator may therefore desire to reduce the average or expected cost of the consolation prize while maintaining a uniform display of wheel 124 (i.e., without changing the values of the prizes or the number of sections associated with the prizes on the wheel). As described more fully below, the cost of the consolation prize may be reduced by adjusting the probability of selecting each section 402 of a virtual wheel 124 using randomization device 1014.

For a wheel 124 having a number of different prize categories n arranged from the lowest value prize category to the highest value prize category, an expected or average cost C for the wheel prizes can be written as:

C=S₁V₁P₁+S₂V₂P₂+ . . . SₙVₙPₙ Eq. 1

where Sₙ is the number of wheel sections 402 associated with prize category n, Vₙ is the value of each prize in the prize category n, and Pₙ is the probability of selecting the section Sₙ associated with prize category n. For example, if an 8 section wheel 124 has 6 sections 402 associated with a $25 prize, 1 section 402 associated with a $50 prize, and 1 section 402 associated with a $100 prize, S₁ is equal to 6, V₁ is equal to $25, P₁ is equal to 0.125, S₂ is equal to 1, V₂ is equal to $50, P₂ is equal to 0.125, S₃ is equal to 1, V₃ is equal to $100, and P₃ is equal to 0.125 assuming that the sections 402 are all equal in size such that each section 402 has the same probability (0.125) of being selected during a spin of wheel 124.

It should be recognized that the sum of all probabilities of selecting sections 402 must equal 1 (or 100%). Therefore, S₁+S₂P₂+ . . . SₙPₙ must equal 1.

In a typical wheel 124, each wheel section 402 has an equal probability of being selected. Therefore, Eq. 1 can be rewritten in terms of an initial probability P₀ such that P₁=P₂=Pₙ=P₀, where P₀ is equal to 1 divided by the number of sections 402 of wheel 124.

C=S₁V₁P₀+S₂V₂P₀+ . . . SₙVₙP₀ Eq. 2

Using the values identified above for an 8 section wheel 124, the average or expected cost C is equal to $37.50.

As described above, for virtual or computer-implemented wheels 124, the probability of each section 402 being selected is driven by a random number generator or the like, such as randomization device 1014. As a result, the probability of each section 402 being selected may be programmed or changed to any desired value. Accordingly, even though wheel 124 may be displayed on display 910, for example, with equally sized sections 402 (thus creating the impression that each section 402 has an equal probability of being selected), the actual probability of each section 402 being selected may be different from what is visually apparent.

If an operator wants to reduce the average or expected cost for the wheel prizes while maintaining the visual display of the wheel 124, the probability of one or more sections 402 being selected may be adjusted. For example, if the operator wants to reduce the cost of the wheel prizes, the probability of section(s) 402 associated with the largest or highest value prize may be reduced and the probability of one or more sections 402 associated with lower value prizes may be increased. In one example, the probability of the highest value section 402 may be decreased and the probability of each other section 402 may be proportionally increased. Eq. 3 represents this exemplary adjustment of the probabilities to achieve a cost reduction percentage of R:

C−CR=S₁V₁(P₀+x)+S₂V₂(P₀+x)+ . . . SₙVₙ(P₀−y) Eq. 3

where x is the increased probability to select sections 402 associated with lower valued prizes V₁−Vₙ₋₁ and y is the reduced probability to select section(s) 402 associated with the highest valued prize Vₙ. While the probability of sections 402 associated with other high valued prizes may be reduced instead of, or in addition to, section(s) 402 associated with Vₙ, the following discussion will just focus on adjusting the probability of selecting section(s) 402 associated with Vₙ.

Since the probabilities of selecting each section 402 must total 100% (or 1), any reduction in y must be offset by a proportional increase in x. These adjustments to x and y are dependent upon the number of sections 402 associated with each prize category. Since S₁P₁+S₂P₂+ . . . SₙPₙ must equal 1 as described above, the sum of the adjusted probabilities must also equal 1 as set forth in Eq. 4:

S₁(P₁+x)+S₂(P₂+x)+ . . . Sₙ(Pₙ−y)=1 Eq. 4

Expanding Eq. 4 yields:

S₁P₁+S₁x+S₂P₂+S₂x+ . . . SₙPₙ−Sₙy=1 Eq. 5

Since again, S₁P₁+S₂P₂+ . . . SₙPₙ=1, Eq. 5 may be simplified:

S₁x+S₂x+ . . . −Sₙy=0 Eq. 6

Y, therefore, may be described in terms of x as set forth in Eq. 7:

y=x(S₁+S₂+ . . . Sₙ₋₁)/Sₙ Eq. 7

Eq. 3 may be recharacterized in terms of x as set forth in Eq. 8:

C−CR=S₁V₁(P₀+x)+S₂V₂(P₀+x)+ . . . SₙVₙ(P₀−x(S₁+S₂+ . . . Sₙ₋₁)/Sₙ) Eq. 8

which can be expanded to yield:

C−CR=S₁V₁P₀S₁V₁x+S₂V₂P₀+S₂V₂x+ . . . SₙVₙP₀−Vₙx(S₁+S₂+ . . . S_{n- 1}) Eq. 9

Since Eq. 2 above established that C is equal to the sum of the S₁V₁P₀ through SₙVₙP₀ terms, we can simplify the equation accordingly:

−CR=S₁V₁x+S₂V₂x+ . . . Sₙ₋₁Vₙ₋₁P₀−Vₙx(S₁+S₂+ . . . Sₙ₋₁) Eq. 7

Solving for x yields the following equation:

x=−CR/(S₁V₁+S₂V₂+ . . . Sₙ₋₁Vₙ₋₁−Vₙ(S₁+S₂+ . . . Sₙ₋₁)) Eq. 10

Once x has been calculated, y may be calculated according to Eq. 7. The new probability to select each section associated with the lower level prizes (e.g., all prizes V₁−Vₙ₋₁ except the highest prize Vₙ) is equal to P₀+x. The new probability of selecting the section(s) associated with the highest prize Vₙ is equal to P₀−y.

Using the equations described herein, an operator, game designer, or the like can easily calculate the adjusted probability for each prize that is necessary to effectuate the desired reduction in the average or expected cost of the wheel prizes. For example, using the values identified above for the 8 section wheel 124 that yielded an average cost of $37.50, an operator may choose to reduce the cost by 10% (i.e., by $3.75). Using Eq. 10, the resulting value for x would be 0.0075 and the value for y would be 0.0525. Accordingly, the initial probability P₀ for section 402 associated with the highest prize would be reduced by 0.0525 (i.e., from 0.125 to 0.0725) and the initial probability P₀ for the remaining 7 sections 402 would be increased by 0.0075 (i.e., from 0.125 to 0.1325).

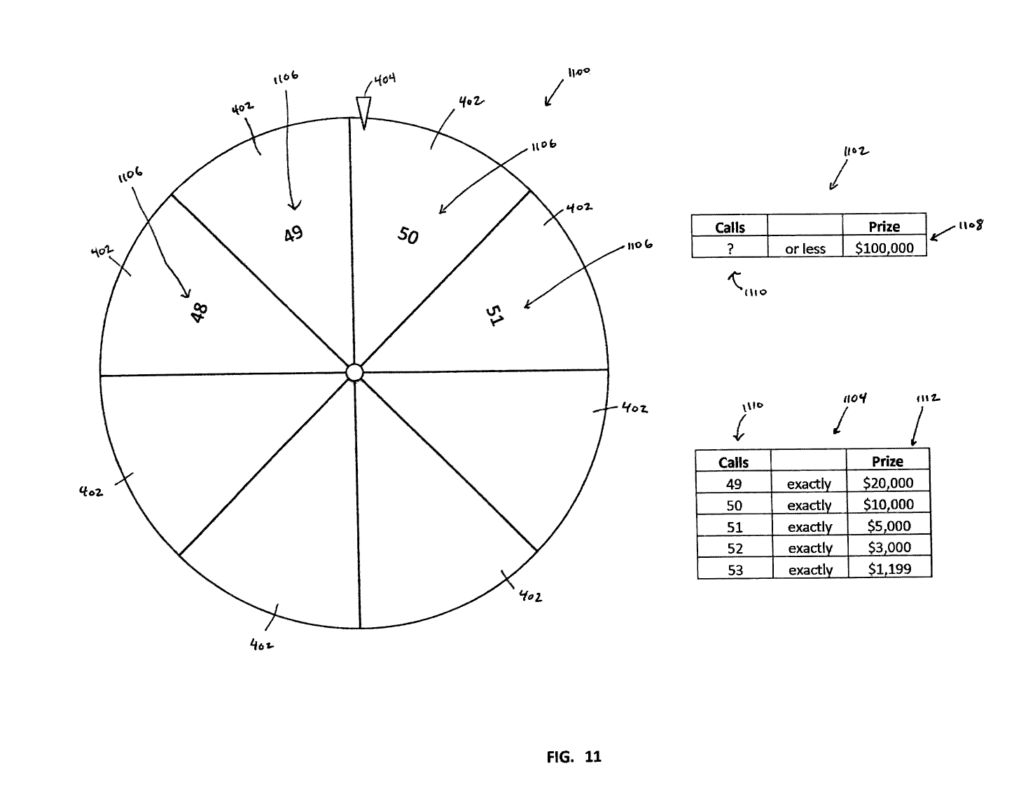

FIG. 11 is a block diagram of an alternative rotatable wheel 1100 that may be used with system 100 (shown in FIG. 1) or system 800 (shown in FIG. 8). In one embodiment, wheel 1100 is substantially similar to wheel 400 (shown in FIG. 4), wheel 600 (shown in FIG. 6), and wheel 700 (shown in FIG. 7), and similar components are labeled in FIG. 11 with the same reference numerals used in FIG. 4, FIG. 6, and FIG. 7. In one embodiment, wheel 1100 is associated with a first pay table 1102 and a second pay table 1104

In one embodiment, wheel 1100 includes a plurality of randomly selectable sections 402 that each includes or displays a house indicia number 1106. House indicia number 1106 may be used to indicate a number of house indicia calls that a matching pattern must be completed within to win a prize on first pay table 1102 and/or second pay table 1104. For example, wheel 1100 may be spun at the beginning of a game to identify house indicia number 1106 associated with a prize for the game.

In one embodiment, first pay table 1102 displays a top prize 1108 (sometimes referred to as a “grand prize”) that may be won if a player card 116 matches a winning pattern within a variable or randomly selectable number of house indicia calls 1110. Top prize 1108 may be a fixed prize, a pari-mutuel prize, or a progressive prize as desired. In one embodiment, the variable or randomly selectable number of house indicia calls 1110 is equal to the number of house indicia calls identified by the house indicia number 1106 selected by wheel 124. For example, if a house indicia number 1106 of 48 is selected during the spin of wheel 1100, top prize 1108 may be awarded to a player card 116 for matching the winning pattern within 48 house indicia calls.

Second pay table 1104 may display a list of prizes 1112 that are awardable if a player card 116 matches a winning pattern within the number of house indicia calls 1110 identified by second pay table 1104. It should be recognized that first pay table 1102 and second pay table 1104 may both be active in the same game such that players may win prizes on whichever pay table (i.e., first pay table 1102 or second pay table 1104) according to the number of house indicia calls 1110 required to achieve the winning pattern. However, if as a result of the wheel spin, top prize 1108 of first pay table 1102 is awardable for a number of house indicia calls 1110 that also appears on second pay table 1104, only the highest value prize may be awarded for achieving a winning pattern. For example, the wheel spin may result in a house indicia number 1106 of 50 being selected such that top prize 1108 is awardable for achieving a winning pattern within 50 house indicia calls. Since second pay table 1104 also displays a prize for achieving a winning pattern within 50 house indicia calls, a player card 116 that achieves the winning pattern within 50 house indicia calls will receive top prize 1108 of first pay table 1102 instead of the associated prize on second pay table 1104. Alternatively, in some embodiments, if a player card 116 achieves a winning pattern within a number of house indicia calls such that a prize would normally be awardable under both first pay table 1102 and second pay table 1104, player card 116 may be awarded both the prize awardable under first pay table 1102 and the prize awardable under second pay table 1104.

While first pay table 1102 and second pay table 1104 are displayed in FIG. 11 as being separate pay tables, it should be recognized that first pay table 1102 and second pay table 1104 may be combined into one unified pay table or may be split into additional pay tables as desired.

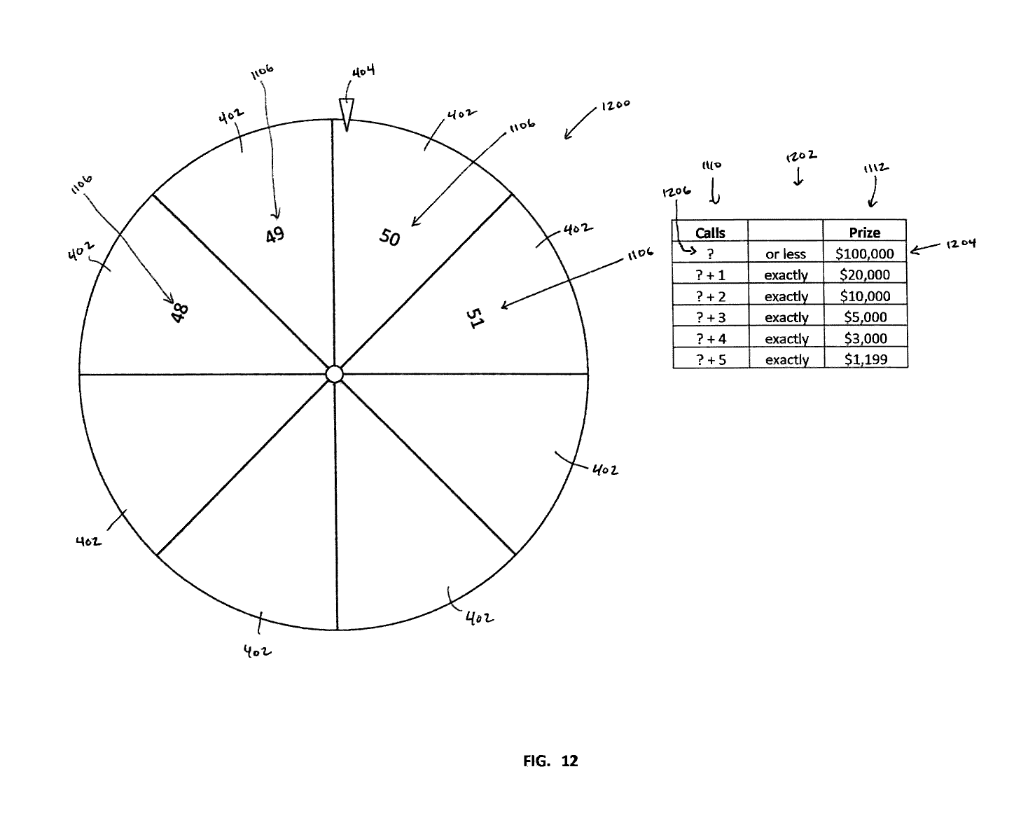

FIG. 12 is a block diagram of an alternative rotatable wheel 1200 that may be used with system 100 (shown in FIG. 1) or system 800 (shown in FIG. 8). In one embodiment, wheel 1200 is substantially similar to wheel 1100 (shown in FIG. 11), and similar components are labeled in FIG. 12 with the same reference numerals used in FIG. 11. In one embodiment, wheel 1200 is associated with a pay table 1202.

In one embodiment, wheel 1200 includes a plurality of randomly selectable sections 402 that each includes or displays a house indicia number 1106. House indicia number 1106 may be used to indicate a number of house indicia calls that a matching pattern must be completed within to win one or more prizes on pay table 1202. For example, wheel 1200 may be spun at the beginning of a game to identify house indicia number 1106 associated with one or more prizes for the game.

In one embodiment, pay table 1202 displays a plurality of prizes 1112 that may be won by matching a winning pattern within a variable or randomly selectable number of house indicia calls 1110. In one embodiment, pay table 1202 includes a first prize 1204 that is awardable if the winning pattern is matched within a first number of house indicia calls 1206. First number of house indicia calls 1206 is randomly selectable by wheel 1200 (i.e., is equal to house indicia number 1106 selected by wheel 1200). The remaining prizes 1112 on pay table 1202 are awarded if the winning pattern is matched within successive numbers of house indicia calls 1110 after first number of house indicia calls 1206. For example, if wheel 1200 selects a house indicia number 1106 of 49, first number of house indicia calls 1206 of pay table 1202 is equal to 49 such that first prize 1204 of $100,000 is awarded if the winning pattern is matched within 49 house indicia calls. The next (or second) prize 1112 of $20,000 is awarded if the winning pattern is matched within 50 house indicia calls 1110 (i.e., the first number of house indicia calls 1206 plus 1), the next (or third) prize 1112 of $10,000 is awarded if the winning pattern is matched within 51 house indicia calls 1110 (i.e., the first number of house indicia calls 1206 plus 2), and so forth.

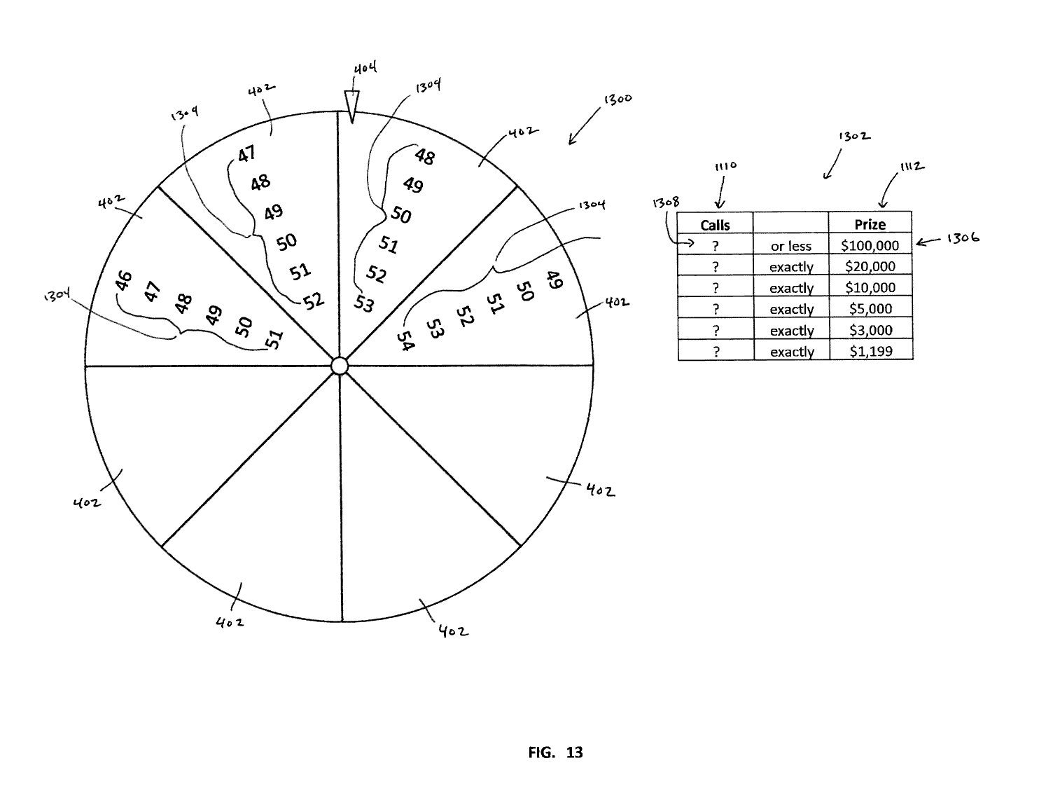

FIG. 13 is a block diagram of an alternative rotatable wheel 1300 that may be used with system 100 (shown in FIG. 1) or system 800 (shown in FIG. 8). In one embodiment, wheel 1300 is substantially similar to wheel 1100 (shown in FIG. 11), and similar components are labeled in FIG. 13 with the same reference numerals used in FIG. 11. In one embodiment, wheel 1300 is associated with a pay table 1302.

In one embodiment, wheel 1300 includes a plurality of randomly selectable sections 402 that each includes or displays a range of house indicia numbers 1304. Range of house indicia numbers 1304 may be used to indicate a range of house indicia calls that a matching pattern must be completed within to win one or more prizes on pay table 1302. For example, wheel 1300 may be spun at the beginning of a game to identify range of house indicia numbers 1304 associated with one or more prizes for the game.

In one embodiment, pay table 1302 displays a plurality of prizes 1112 that may be won by matching a winning pattern within a variable or randomly selectable number of house indicia calls 1110. In one embodiment, pay table 1302 includes a first prize 1306 that is awardable if the winning pattern is matched within a first number of house indicia calls 1308. First number of house indicia calls 1308 is equal to the first number within range of house indicia numbers 1304 selected by wheel 1300. Each successive prize 1112 on pay table 1302 is awarded if the winning pattern is matched within the next number of house indicia calls 1110 within the selected range of house indicia numbers 1304. For example, if wheel 1300 selects a range of house indicia numbers 1304 of 46, 47, 48, 49, 50, and 51, first number of house indicia calls 1308 of pay table 1302 is equal to 46 such that first prize 1306 of $100,000 is awarded if the winning pattern is matched within 46 house indicia calls. The next (or second) prize 1112 of $20,000 is awarded if the winning pattern is matched within 47 house indicia calls 1110 (i.e., the second number within the selected range of house indicia numbers 1304), the next (or third) prize 1112 of $10,000 is awarded if the winning pattern is matched within 48 house indicia calls 1110 (i.e., the third number within the selected range of house indicia numbers 1304), and so forth.

As described above with reference to FIGS. 11-13, the randomly selectable number of house indicia calls needed to win prizes on the pay tables described herein adds excitement to the play of the games of chance. Players may have the opportunity to win large prizes in a fewer amount of house indicia calls as compared to other pay tables and systems. Additionally, the operator of the games of chance may adjust the probabilities of the house indicia numbers selected by the wheel and may also adjust the pay table prizes to produce a desired amount of expected profit from the games.

Exemplary embodiments of rotatable wheels for games of chance and associated devices and systems are described above in detail. The wheels, devices, and systems are not limited to the specific embodiments described herein, but rather, components of the wheels, devices, and/or systems may be utilized independently and separately from other components described herein. For example, the wheels, devices, and systems may also be used in combination with other games, and are not limited to practice with only the bingo and keno games of chance as described herein.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

In addition, components of devices or systems described herein may be used in, and/or combined with, other devices or systems described herein unless otherwise specified. Likewise, the functionality of the systems and devices described herein may be used in, combined with, and/or incorporated into other systems and devices described herein unless otherwise specified. For example, two or more of the systems or devices described herein may be combined together, and/or one or more of the systems or devices described herein may be split into two or more other systems or devices.

Unless otherwise specified, “a” or “an” means one or more of a referenced object or step. Furthermore, unless otherwise specified, each method described herein is not limited to the order in which the steps of each method are described or introduced. Rather, the steps may be rearranged in any suitable order, may be omitted, and/or may be combined with steps of other methods as desired. In addition, aspects or components of each embodiment and/or figure described herein may be omitted, or may be combined with, or modified to include, aspects or components of any other embodiment and/or figure unless otherwise specified.

Unless otherwise specified, the phrase “at least one of A and B” means one or more of A alone, one or more of B alone, or one or more of the combination of A and B.

This written description uses examples to describe embodiments of the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
at least one player card comprising a plurality of player indicia usable by a player to play a game of chance;
a randomization device configured to randomly select a plurality of house indicia for the game of chance;
a computing device comprising:
an input device configured to receive a physical item associated with a monetary value;
a user interface configured to:
enable the player to select a wager for the game of chance; and
enable the player to initiate a cash out operation; and
a processor programmed to:
add the monetary value to a credit balance for the player;
deduct the selected wager from the credit balance;
determine whether said at least one player card satisfies a winning criterion based on matching at least one of the plurality of player indicia with at least one of the plurality of house indicia; and
decrease the credit balance in response to the cash out operation;
a pay table comprising:
at least one base prize that is awardable for said at least one player card satisfying the winning criterion; and
an option for the player of said at least one player card to either receive the at least one base prize or to receive one of a plurality of randomly selectable prizes; and
a rotatable wheel comprising the plurality of randomly selectable prizes that are selectable by rotating said wheel.

2. The system of claim 1, wherein the plurality of randomly selectable prizes includes a prize that is double the at least one base prize.

3. The system of claim 1, wherein the plurality of randomly selectable prizes includes a prize that is triple the at least one base prize.

4. The system of claim 1, wherein the plurality of randomly selectable prizes includes a prize of $0 that causes the player to lose the at least one base prize.

5. The system of claim 1, wherein the plurality of randomly selectable prizes includes a prize that awards a free spin of said rotatable wheel to the player.

6. The system of claim 1, wherein the plurality of randomly selectable prizes includes a prize that awards a free game of the game of chance to the player.

7. The system of claim 1, wherein the winning criterion includes matching a predetermined pattern of the player indicia with the selected plurality of house indicia.

8. The system of claim 1, wherein the winning criterion includes matching a predetermined number of the player indicia with the selected plurality of house indicia.

9. A system comprising:
at least one player card comprising a plurality of player indicia usable by a player to play a game of chance, wherein the player is enabled to select each player indicia of the plurality of player indicia;
a randomization device configured to randomly select a plurality of house indicia for the game of chance;
a computing device comprising:
an input device configured to receive a physical item associated with a monetary value;
a user interface configured to:
enable the player to select a wager for the game of chance; and
enable the player to initiate a cash out operation; and
a processor programmed to:
add the monetary value to a credit balance for the player;
deduct the selected wager from the credit balance;
determine whether said at least one player card satisfies a winning criterion based on matching at least one of the plurality of player indicia with at least one of the plurality of house indicia; and
decrease the credit balance in response to the cash out operation;
a pay table comprising at least one base prize that is awardable for said at least one player card satisfying the winning criterion; and
a rotatable wheel comprising a plurality of sections that are selectable by rotating said rotatable wheel, wherein each player indicia of the pool of player indicia is associated with a respective section of said plurality of sections, and wherein the at least one base prize is increased if a player indicia associated with said selected section matches a player indicia within said at least one player card.

10. The system of claim 9, wherein the at least one base prize is doubled if a player indicia associated with said selected section matches a player indicia within said at least one player card.

11. The system of claim 9, wherein the at least one base prize is tripled if a player indicia associated with said selected section matches a player indicia within said at least one player card.

12. The system of claim 9, wherein said plurality of sections comprises at least one section associated with an indicia that causes the player to lose the at least one base prize.

13. The system of claim 9, wherein said plurality of sections comprises at least one section associated with an indicia that awards the player a free spin of said rotatable wheel.

14. The system of claim 9, wherein said plurality of sections comprises at least one section associated with an indicia that awards the player at least one free game of the game of chance.

15. The system of claim 9, wherein said plurality of sections comprises at least one section associated with an indicia that awards the player a separate prize in addition to the at least one base prize.

16. The system of claim 9, wherein the winning criterion includes matching a predetermined pattern of the player indicia with the selected plurality of house indicia.

17. The system of claim 9, wherein the winning criterion includes matching a predetermined number of the player indicia with the selected plurality of house indicia.

18. A system comprising:
a plurality of player cards, wherein each said player card is usable by a player of a plurality of players to play a game of chance and wherein each said player card comprises a plurality of player indicia;
a randomization device configured to randomly select a plurality of house indicia for the game of chance;
a computing device comprising:
an input device configured to receive a physical item associated with a monetary value;
a user interface configured to:
enable the player to select a wager for the game of chance; and
enable the player to initiate a cash out operation; and
a processor programmed to:
add the monetary value to a credit balance for the player;
deduct the selected wager from the credit balance;
determine whether any player card of said plurality of player cards satisfies a winning criterion based on matching at least one of the plurality of player indicia with at least one of the plurality of house indicia; and
decrease the credit balance in response to the cash out operation;
a pay table comprising at least one base prize that is awardable for said player card that satisfies the winning criterion; and
a rotatable wheel comprising a plurality of randomly selectable prizes that are selectable by rotating said wheel, wherein a selected prize of the plurality of randomly selectable prizes is awarded to each player of the plurality of players.

19. The system of claim 18, wherein the plurality of randomly selectable prizes comprises a prize that is less than the at least one base prize.

20. The system of claim 18, wherein the plurality of randomly selectable prizes comprises a prize of $0.

21. The system of claim 18, wherein the plurality of randomly selectable prizes comprises a prize of a free game of the game of chance that is awarded to each player of the plurality of players.

22. The system of claim 18, wherein the winning criterion includes matching a predetermined pattern of the player indicia with the selected plurality of house indicia.

23. The system of claim 18, wherein the winning criterion includes matching a predetermined number of the player indicia with the selected plurality of house indicia.

24. A system comprising:
at least one player card comprising a plurality of player indicia usable by a player to play a first game of chance;
a randomization device configured to randomly select a plurality of house indicia for the first game of chance;
a computing device comprising:
an input device configured to receive a physical item associated with a monetary value;
a user interface configured to:
enable the player to select a wager for the first game of chance; and
enable the player to initiate a cash out operation; and
a processor programmed to:
add the monetary value to a credit balance for the player;
deduct the selected wager from the credit balance;
determine whether said at least one player card satisfies a winning criterion based on matching at least one of the plurality of player indicia with at least one of the plurality of house indicia; and
decrease the credit balance in response to the cash out operation;
a pay table comprising at least one base prize that is awardable for said at least one player card satisfying the winning criterion; and
a rotatable wheel comprising said plurality of randomly selectable sections that are selectable by rotating said wheel, wherein each section of said plurality of randomly selectable sections is associated with one of a plurality of prize multipliers, and wherein a prize multiplier of the plurality of prize multipliers associated with a selected section of said plurality of randomly selectable sections is applied to the at least one base prize in a second game of chance that is played after the first game of chance ends.

25. The system of claim 24, wherein said rotatable wheel is rotated by the player of said at least one player card that satisfies the winning criterion for the first game of chance.

26. The system of claim 24, wherein the first game of chance is one of a first plurality of games played in a first game session and the second game of chance is one of a second plurality of games played in a second game session.

27. The system of claim 26, wherein said rotatable wheel is rotated by the player of said at least one player card that satisfies the winning criterion for the last game of the first plurality of games in the first game session.

28. The system of claim 26, wherein the prize multiplier of the plurality of prize multipliers associated with said selected section of said plurality of randomly selectable sections is applied to the at least one base prize in each game of the second plurality of games in the second game session.

29. The system of claim 24, wherein the plurality of prize multipliers comprises at least one prize multiplier that doubles the at least one base prize in the second game of chance.

30. The system of claim 24, wherein the plurality of prize multipliers comprises at least one prize multiplier that triples the at least one base prize in the second game of chance.

31. The system of claim 24, wherein the winning criterion includes matching a predetermined pattern of the player indicia with the selected plurality of house indicia.

32. The system of claim 24, wherein the winning criterion includes matching a predetermined number of the player indicia with the selected plurality of house indicia.

33. A system comprising:
a plurality of player cards, wherein each said player card is usable by a player of a plurality of players to play a game of chance and wherein each said player card comprises a plurality of player indicia;
a randomization device configured to randomly select a plurality of house indicia for the game of chance;
a computing device comprising:
an input device configured to receive a physical item associated with a monetary value;
a user interface configured to:
enable the player to select a wager for the game of chance; and
enable the player to initiate a cash out operation; and
a processor programmed to:
add the monetary value to a credit balance for the player;
deduct the selected wager from the credit balance;
determine whether any player card of said plurality of player cards satisfies a winning criterion based on matching at least one of the plurality of player indicia with at least one of the plurality of house indicia; and
decrease the credit balance in response to the cash out operation;
a pay table comprising at least one base prize that is awardable for said player card that satisfies the winning criterion; and
a rotatable wheel comprising a plurality of randomly selectable consolation prizes that are selectable by rotating said wheel, wherein a selected consolation prize of the plurality of randomly selectable consolation prizes is awarded to each player of the plurality of players in the event that no player card of said plurality of player cards satisfies the winning criterion.

34. The system of claim 33, wherein the plurality of randomly selectable consolation prizes comprises a consolation prize of $0.

35. The system of claim 33, wherein said rotatable wheel comprises:
an outer ring of sections that includes a first set of the plurality of randomly selectable consolation prizes such that each section of said outer ring of sections comprises a consolation prize of the first set of the plurality of randomly selectable consolation prizes; and
an inner ring of sections that includes a second set of the plurality of randomly selectable consolation prizes such that each section of said inner ring of sections comprises a consolation prize of the second set of the plurality of randomly selectable consolation prizes.

36. The system of claim 35, wherein said rotatable wheel comprises a middle ring of sections positioned between said outer ring of sections and said inner ring of sections, wherein said middle ring of sections comprises a third set of the plurality of randomly selectable consolation prizes such that each section of said middle ring of sections comprises a consolation prize of the third set of the plurality of randomly selectable consolation prizes.

37. The system of claim 36, wherein said outer ring of sections comprises a special symbol that, if selected, enables said rotatable wheel to be rotated to select one of the third set of the plurality of randomly selectable consolation prizes in said middle ring of sections.

38. The system of claim 36, said middle ring of sections comprises a special symbol that, if selected, enables said rotatable wheel to be rotated to select one of the second set of the plurality of randomly selectable consolation prizes in said inner ring of sections.

39. The system of claim 36, wherein an average value of the third set of consolation prizes is greater than an average value of the first set of consolation prizes.

40. The system of claim 39, wherein an average value of the second set of consolation prizes is greater than the average value of the third set of consolation prizes.

41. The system of claim 33, wherein the winning criterion includes matching a predetermined pattern of the player indicia with the selected plurality of house indicia.

42. The system of claim 33, wherein the winning criterion includes matching a predetermined number of the player indicia with the selected plurality of house indicia.

43. A system comprising:
at least one player card that is usable by a player to play a game of chance, wherein said at least one player card comprises a plurality of player indicia;
a randomization device configured to randomly select a plurality of house indicia for the game of chance;
a computing device comprising:
an input device configured to receive a physical item associated with a monetary value;
a user interface configured to:
enable the player to select a wager for the game of chance; and
enable the player to initiate a cash out operation; and
a processor programmed to:
add the monetary value to a credit balance for the player;
deduct the selected wager from the credit balance;
determine whether said at least one player card satisfies a winning criterion based on matching at least one of the plurality of player indicia with at least one of the plurality of house indicia; and
decrease the credit balance in response to the cash out operation;
a rotatable wheel comprising a plurality of sections that are randomly selectable by rotating said wheel, wherein each said section is associated with a house indicia number; and
a pay table comprising at least one prize that is awardable for said at least one player card satisfying the winning criterion within a variable number of house indicia calls.

44. The system of claim 43, wherein the variable number of house indicia calls is equal to the house indicia number associated with said randomly selected section.

45. The system of claim 44, wherein said pay table is a first pay table of a plurality of pay tables, and wherein a second pay table of said plurality of pay tables comprises at least one prize that is awardable for said at least one player card satisfying the winning criterion within a fixed number of house indicia calls.

46. The system of claim 44, wherein the at least one prize includes a plurality of prizes, and wherein a first prize of the plurality of prizes is awardable for said at least one player card satisfying the winning criterion within a first number of house indicia calls equal to the house indicia number associated with said randomly selected section.

47. The system of claim 46, wherein a second prize of the plurality of prizes is awardable for said at least one player card satisfying the winning criterion within a second number of house indicia calls that is equal to the first number of house indicia calls plus 1.

48. A system comprising:
at least one player card that is usable by a player to play a game of chance, wherein said at least one player card comprises a plurality of player indicia;
a randomization device configured to randomly select a plurality of house indicia for the game of chance;
a computing device comprising:
an input device configured to receive a physical item associated with a monetary value;
a user interface configured to:
enable the player to select a wager for the game of chance; and
enable the player to initiate a cash out operation; and
a processor programmed to:
add the monetary value to a credit balance for the player;
deduct the selected wager from the credit balance;
determine whether said at least one player card satisfies a winning criterion based on matching at least one of the plurality of player indicia with at least one of the plurality of house indicia; and
decrease the credit balance in response to the cash out operation;
a rotatable wheel comprising a plurality of sections that are randomly selectable by rotating said wheel, wherein each said section is associated with a range of house indicia numbers; and
a pay table comprising at least one prize that is awardable for said at least one player card satisfying the winning criterion within a variable number of house indicia calls.

49. The system of claim 48, wherein the variable number of house indicia calls is equal to a first house indicia number within the range of house indicia numbers associated with said randomly selected section.

50. The system of claim 48, wherein the at least one prize includes a plurality of prizes, and wherein a first prize of the plurality of prizes is awardable for said at least one player card satisfying the winning criterion within a first number of house indicia calls equal to a first house indicia number of the range of house indicia numbers associated with said randomly selected section.

51. The system of claim 50, wherein a second prize of the plurality of prizes is awardable for said at least one player card satisfying the winning criterion within a second number of house indicia calls equal to a second house indicia number of the range of house indicia numbers associated with said randomly selected section.

52. The system of claim 48, wherein the range of house indicia numbers of at least one section of the plurality of sections is different than the range of house indicia numbers of at least one other section of the plurality of sections.

53. A system comprising:
at least one player card that is usable by a player to play a game of chance, wherein said at least one player card comprises a plurality of player indicia;
a randomization device configured to randomly select a plurality of house indicia for the game of chance;
a rotatable wheel comprising a plurality of sections that are randomly selectable by rotating said wheel, wherein each said section is associated with a prize; and
a computing device comprising:
an input device configured to receive a physical item associated with a monetary value;
a user interface configured to:
enable the player to select a wager for the game of chance; and
enable the player to initiate a cash out operation; and
a processor programmed to:
add the monetary value to a credit balance for the player;
deduct the selected wager from the credit balance;
calculate an average cost of the prizes associated with said sections selectable by said rotatable wheel;
reduce the average cost of the prizes without changing a value of each prize; and
decrease the credit balance in response to the cash out operation.

54. The system of claim 53, wherein the prize associated with said randomly selected section is awardable regardless of whether said at least one player card satisfies a winning criterion.

55. The system of claim 53, wherein reducing the average cost includes adjusting a probability of at least two sections of said plurality of sections being selected.

56. The system of claim 55, a first section of said at least two sections is associated with a first prize having the highest value of all the prizes associated with said sections, and a second section of said at least two sections is associated with a second prize having the lowest value of all the prizes associated with said sections.

57. The system of claim 56, wherein adjusting the probability of said at least two sections includes decreasing the probability of said first section being selected and increasing the probability of said second section being selected.

58. The system of claim 53, wherein each prize is grouped into a prize category n according to a value of each prize, and wherein said computing device is configured to calculate the average cost (C) according to:
C=S₁V₁P₁+S₂V₂P₂+ . . . SₙVₙPₙ
wherein Sₙ is a number of said sections included within said rotatable wheel associated with prize category n, Vₙ is the value of the prize in the prize category n, and Pₙ is a probability of selecting the section Sₙ associated with prize category n.

59. The system of claim 58, wherein said computing device is configured to reduce the average cost by a percentage R by calculating:
C−CR=S₁V₁(P₀+x)+S₂V₂(P₀+x)+ . . . SₙVₙ(P₀−y)
wherein x is an increased probability to select said sections associated with the prizes V₁−Vₙ₋₁ and y is a reduction in the probability to select said section associated with prize Vₙ, wherein the value of the prize Vₙ is higher than the value of the prizes V₁−Vₙ₋₁.

60. The system of claim 59, wherein said computing device is configured to calculate x as:
x=−CR/(S₁V₁+S₂V₂+ . . . Sₙ₋₁Vₙ₋₁−Vₙ(S₁+S₂+ . . . Sₙ₋₁)).

61. The system of claim 60, wherein said computing device is configured to calculate y as:
y=x(S₁+S₂ . . . Sₙ₋₁)/Sₙ.
